(19) United States
(12) Patent Application Publication
(10) Pub. No.: US 2011/0248209 A1
(43) Pub. Date: Oct. 13, 2011

(54) THERMOELECTRIC FIGURE OF MERIT ENHANCEMENT BY MODIFICATION OF THE ELECTRONIC DENSITY OF STATES

(75) Inventors: John Androulakis, Evanston, IL (US); Yibin Gao, Columbus, OH (US); Steven N. Girard, Chicago, IL (US); Joseph Heremans, Upper Arlington, OH (US); Christopher Jaworski, Columbus, OH (US); Mercouri G. Kanatzidis, Wilmette, IL (US)

(73) Assignees: NORTHWESTERN UNIVERSITY, Evanston, IL (US); THE OHIO STATE UNIVERSITY, Columbus, OH (US)

(21) Appl. No.: 13/045,998

(22) Filed: Mar. 11, 2011

Related U.S. Application Data
(60) Provisional application No. 61/313,560, filed on Mar. 12, 2010.

(51) Int. Cl. H01B 1/02; C09K 5/14

(52) U.S. Cl. 252/71

(57) ABSTRACT

A thermoelectric material and a method of using a thermoelectric material is provided. The thermoelectric material can include at least one compound. For example, the at least one compound may be a Group IV-VI compound such as lead telluride. The at least one compound may further include one or more dopants such as sodium, potassium, and thallium. The method of using a thermoelectric material can include exposing at least one portion of the at least one compound to a temperature greater than about 700 K.

### CROSS-REFERENCE TO RELATED APPLICATIONS

This application claims the benefit of U.S. Provisional Application No. 61/313,560, filed Mar. 12, 2010, the entirety of which is hereby incorporated by reference.

### BACKGROUND

1. Field

Embodiments of the present disclosure are directed toward thermoelectric materials. Embodiments also relate to doped Group IV-VI semiconductor compounds.

2. Description of the Related Art

Thermoelectric (TE) energy conversion is an all-solid-state technology used in heat pumps and electrical power generators. In essence, TE coolers and generators are heat engines thermodynamically similar to conventional vapor power generator or heat pump systems, but they use electrons as the working fluid instead of physical gases or liquids. Thus, TE coolers and generators have no moving fluids or moving parts and have the inherent advantages of reliability, silent and vibration-free operation, a very high power density, and the ability to maintain their efficiency in small-scale applications where only a moderate amount of power is needed. In addition, TE power generators directly convert temperature gradients and heat into electrical voltages and power, without the additional need for an electromechanical generator.

All of these properties make them particularly suited for recovering electrical power from otherwise wasted heat, for instance in automotive exhaust systems or solar energy converters. These advantages are partially offset by the relatively low efficiency of commercially available material, limiting the use of the technology to niche applications for the past half century. Recent efforts have focused on nanostructured materials to enhance the TE efficiency. Further examples of TE power systems are disclosed in U.S. Pat. Nos. 6,539,725, 7,231,772, 6,959,555, 6,625,990, and 7,273,981, which are incorporated herein in their entirety by reference.

The efficiency of thermoelectric generators is limited to a fraction of their Carnot efficiency (η_{c}=ΔT/T_{H}), determined by the dimensionless thermoelectric material figure of merit (1), ZT:

$$ZT = T \frac{{S}^{2} σ}{κ} \qquad ( 1 )$$

where S is the thermoelectric power or Seebeck coefficient of the TE material, σ and κ are the electrical and thermal conductivities, respectively, and T is the absolute temperature. For the past four decades, ZT of commercial material has been limited to about 1 in all temperature ranges (G. J. Snyder, E. S. Toberer, Nat. Mater., Vol. 7, pp. 105 (2008)).

The lead chalcogenides, and in particular PbTe, are prime materials for thermoelectric applications above about 200° C. (C. Wood, Rep. Prog. Phys., Vol. 51, pp. 459-539 (1988)). Dopants of indium, gallium, thallium, and cadmium introduced in PbTe form impurity levels (V. I. Kaidanov, Yu. I. Ravich, Sov. Phys. Usp., Vol. 28, pp. 31 (1985)) that are known to pin the Fermi energy at the impurity level itself. The energy level associated with indium impurities are about 70 meV (Kaidanov et al.; S. A. Nemov, Yu. I. Ravich, A. V. Berezin, V. E. Gasumyants, M. K. Zhitinskaya, V. I. Proshin, Semicond., Vol. 27 pp. 165 (1993)) inside the conduction band, as measured from the bottom of conduction band in PbTe (V. G. Golubev, N. I. Grecho, S. N. Lykov, E. P. Sabo, I. A. Chernik, Sov. Phys. Semicond., Vol. 11, pp. 1001 (1977); V. I. Kaidanov, R. B. MeI'nik, I. A. Chernik, Sov. Phys. Semicond. 7 759 (1973)). Therefore, chemical doping of these alloys can increase the Fermi energy beyond 70 meV only if the dopant concentration exceeds that of indium.

A study by Nemov et al. performed on Pb_{0.78}Sn_{0.22}Te with less than 3% indium showed a half-filled In—Te band and a Fermi level, E_{F}, stabilized at the impurity level positioned below the bottom of the conduction band edge. At indium concentrations above 5%, E_{F} would be positioned within k_{B}T of the impurity level, where k_{B} is Boltzmann's constant and T is the temperature. By measuring the temperature dependence of the Hall coefficient and the resistivity ρ, Nemov et al. determined the energy derivative of density of states, dg(E)/dE, and found that the gap between the impurity states and the conduction band disappears while dg(E)/dE becomes negative. This result implies that the energy band of the host semiconductor, here PbTe, hybridizes with the energy levels of the impurity and in this way, the impurity may form a resonant state in the band of the host semiconductor.

The existence of such a resonant state in the vicinity of the Fermi level results in a strong distortion of the density of states (DOS). The density of states' energy dependence, g(E), develops sharp, delta-shaped features which, following the theory of Mahan and Sofo (G. D. Mahan and J. O, Sofo, Proc. Natl. Acad. Sci. USA, Vol. 93, pp. 7436 (1996)), can improve the thermoelectric figure of merit, ZT. This result can be expressed using the Mott relation:

$$S = \frac{{π}^{2}}{3} \frac{{k}_{B}}{q} {k}_{B} T {\{ \frac{d [ ln ( σ ( E ) ) ]}{d E} \}}_{E = {E}_{F}} = \frac{{π}^{2}}{3} \frac{{k}_{B}}{q} {k}_{B} T {\{ \frac{1}{n} \frac{d n ( E )}{d E} + \frac{1}{μ} \frac{d μ ( E )}{d E} \}}_{E = {E}_{F}} \qquad ( 2 )$$

which predicts that a strongly energy-dependent density of states, resulting in a strong dn(E)/dE term in equation (2), should provide a higher value of the Seebeck coefficient S(n) at a given carrier concentration n than that of a simple parabolic or non-parabolic band. The dependence of the Seebeck coefficient S on the carrier concentration n is called the Pisarenko relation. (see, e.g., F. Ioffe, Physics of Semiconductors (Academic Press, New York, 1960)).

### SUMMARY

In certain embodiments, a thermoelectric material is provide. The thermoelectric material can include at least one compound having a general composition of A_{w-t}Te₁₋ᵣEᵣDₜ, wherein w>t, 0<r≦0.30, 0<t≦0.05, and wherein A is selected from the group consisting of lead and tin, Te is tellurium, D is selected from the group consisting of sodium, potassium, thallium, and E is selected from the group consisting of sulfur and selenium. The at least one compound may be p-type.

In some embodiments, the thermoelectric material has components in the range of 0.08≦r≦0.12, 0.01≦t≦0.03, and/or 0.94≦w≦1.06. Embodiments include, for example, the component D comprises thallium and the component E may comprise sulfur, the component D may comprises sodium and the component E may comprise sulfur, the component D may comprises potassium and the component E may comprise sulfur, the component A may comprises tin and the component D may comprise indium and the component E may comprise selenium.

In certain embodiments, a thermoelectric material comprises at least one compound having a general composition of A_{w-t}Te₁Dₜ, wherein w>t, 0<t≦0.05, wherein A is selected from the group consisting of lead and tin, Te is tellurium, and D consists of sodium and potassium. In some embodiments, the thermoelectric material has components in the range of 0.01≦t≦0.03 and/or 0.94≦w≦1.06. In further embodiments, at least 10 atomic % of D is sodium and at least 10 atomic % of D is potassium. The at least one compound may further comprises thallium. The at least one compound can also be p-type.

In certain embodiments, a method of using a thermoelectric material is provided. The method can include providing a thermoelectric material comprising at least one compound having a general composition of A_{w-t}Te₁Dₜ, wherein w>t, 0<t≦0.05, wherein A is selected from the group consisting of lead and tin, Te is tellurium, and D consists of sodium and thallium. The method can further include exposing at least one portion of the at least one compound to a temperature greater than about 550 K during use of the thermoelectric material. In some embodiments, the thermoelectric material has components in the range of 0.01≦t≦0.03. The at least one compound may further include potassium. In certain embodiment, the at least one portion of the at least one compound is exposed to a temperature greater than about 700 K during use of the thermoelectric material. In further embodiments, the at least one compound comprises a thermoelectric figure of merit greater than 1 at temperatures between about 550 K and about 700 K.

In certain embodiments, a method of using a thermoelectric material includes providing a thermoelectric material comprising at least one compound having a general composition of A_{w-t}Te₁Dₜ, wherein w>t, 0<t≦0.05, wherein A is selected from the group consisting of lead and tin, Te is tellurium, and D consists of indium. The method can further include exposing at least one portion of the at least one compound to a temperature greater than about 550 K during use of the thermoelectric material. In some embodiments, the thermoelectric material has components in the range of 0.01≦t≦0.03. The at least one compound may further include selenium. For example, a concentration of the selenium can be between about 0.5 and about 5 atomic percent of the at least one compound. In further embodiments, component A consists essentially of tin.

### BRIEF DESCRIPTION OF THE DRAWINGS

FIG. 1 is a plot of the temperature dependence of the electrical resistivity of two sample thermoelectric materials compatible with certain embodiments described herein.

FIG. 2 is a plot of the temperature dependence of the Seebeck coefficients of the samples of FIG. 1.

FIG. 3 is a plot of the temperature dependence of the calculated figure of merit ZT from the data of FIGS. 1 and 2.

FIG. 4 is a plot of the temperature dependence of the thermal conductivity of the sample with 2 atomic % thallium.

FIG. 5 is a plot of temperature dependence of the low-field Hall coefficient (top frame), the Hall mobility (dots, bottom frame, left ordinate), and the Nernst coefficient (+symbols, bottom frame, right ordinate) of the Tl_{0.02}Pb_{0.98}Te sample in FIG. 8. The open and closed symbols represent data taken in two different measurement systems.

FIG. 6 is a plot of the Seebeck coefficient versus carrier density, with the value for a sample compatible with certain embodiments described herein at 300 K shown as the circle datapoint and the Pisarenko curve valid for conventionally doped PbTe shown as the solid curve.

FIG. 7 includes plots of the temperature dependence of the (A) resistivity, (B) Seebeck coefficient, and (C) thermal conductivity of a representative sample of Tl_{0.02}Pb_{0.98}Te (squares) and of Tl_{0.01}Pb_{0.99}Te (circles). The open and closed symbols represent data taken in two different measurement systems.

FIG. 8A includes a schematic representation of the density of electron states of the valence band of pure PbTe (dashed line) contrasted to that of Tl—PbTe in which a Tl-related level increases the density of states. The figure of merit ZT is optimized when the Fermi energy E_{F} of the holes in the band falls in the energy range E_{R} of the distortion;

FIG. 8B is a plot of ZT values for Tl_{0.02}Pb_{0.98}Te (squares) and Tl_{0.01}Pb_{0.99}Te (circles) compared to that of a reference sample of Na—PbTe (diamonds).

FIG. 9 is a plot of the temperature dependence of the Fermi energy (+symbols, right ordinate, the zero referring to the top of the valence band) and of the density of states effective mass (dots, left ordinate) of Tl_{0.02}Pb_{0.98}Te compared to that of Na—PbTe (dashed line).

FIG. 10 is a plot of thermoelectric figure of merit (ZT) as a function of temperature for the sample of Pb₉₇Tl₂Na₁Te₉₂S₈.

FIG. 11 illustrates a phase diagram between PbTe and TlTe of concentration of thallium as a function of temperature.

FIG. 12 is a plot of thermoelectric figure of merit (ZT) as a function of temperature for the sample of Pb₉₇Tl₂Na₁Te₉₂S₈.

FIG. 13 is a plot of measured electrical resistivity as a function of temperature for the sample of Pb₉₇Tl₂Na₁Te₉₂S₈.

FIG. 14 is a plot of Seebeck coefficient as a function of temperature for the sample of Pb₉₇Tl₂Na₁Te₉₂S₈.

FIG. 15 is a plot of power factor as a function of temperature for the sample of Pb₉₇Tl₂Na₁Te₉₂S₈.

FIG. 16 is a plot of thermal conductivity (kappa) as a function of temperature for the sample of Pb₉₇Tl₂Na₁Te₉₂S₈.

FIG. 17 is a plot of measured electrical conductivity as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 18 is a plot of measured Seebeck coefficient as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 19 is a plot of the power factor as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 20A is a plot of measured total thermal conductivity as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 20B is a plot of measured lattice thermal conductivity as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 21 is a plot of thermoelectric figure of merit (ZT) as a function of temperature for samples of (PbTe_{0.92}S_{0.08})_{0.98}(NaTe)_{0.02} and (PbTe_{0.84}S_{0.16})_{0.98}(NaTe)_{0.02}.

FIG. 22 is a plot of measured electrical conductivity as a function of temperature for samples of (PbTe₁₋ₓSₓ)_{0.98}(NaTe)_{0.02} wherein x equal 0.08, 0.16, and 0.30.

FIG. 23 is a plot of measured Seebeck coefficient as a function of temperature for samples of (PbTe₁₋ₓSₓ)_{0.98}(NaTe)_{0.02} wherein x equals 0.08, 0.16, and 0.30.

FIG. 24 is a plot of the power factor as a function of temperature for samples of (PbTe₁₋ₓSₓ)_{0.98}(NaTe)_{0.02} wherein x equals 0.08, 0.16, and 0.30.

FIG. 25 is a plot of measured total thermal conductivity as a function of temperature for samples of (PbTe₁₋ₓSₓ)_{0.98}(NaTe)_{0.02} wherein x equals 0.08, 0.16, and 0.30.

FIG. 26 is a plot of measured lattice thermal conductivity as a function of temperature for samples of (PbTe₁₋ₓSₓ)_{0.98}(NaTe)_{0.02} wherein x equals 0.08, 0.16, and 0.30.

FIG. 27 is a plot of thermoelectric figure of merit (ZT) as a function of temperature for samples of (PbTe₁₋ₓSₓ)_{0.98}(NaTe)_{0.02} wherein x equals 0.08, 0.16, and 0.30.

FIG. 28 is a plot of measured electrical conductivity as a function of temperature for samples of (PbTe_{0.92}S_{0.08})_{1-q}(Na₂Te)_{q} wherein q equals 0.08, 0.16, and 0.30.

FIG. 29 is a plot of measured Seebeck coefficient as a function of temperature for samples of (PbTe_{0.92}S_{0.08})_{1-q}(Na₂Te)_{q} wherein q equals 0.08, 0.16, and 0.30.

FIG. 30 is a plot of the power factor as a function of temperature for samples of (PbTe_{0.92}S_{0.08})_{1-q}(Na₂Te)_{q} wherein q equals 0.08, 0.16, and 0.30.

FIG. 31 is a plot of measured total thermal conductivity as a function of temperature for samples of (PbTe_{0.92}S_{0.08})_{1-q}(Na₂Te)_{q} wherein q equals 0.08, 0.16, and 0.30.

FIG. 32 is a plot of measured lattice thermal conductivity as a function of temperature for samples of (PbTe_{0.92}S_{0.08})_{1-q}(Na₂Te)_{q} wherein q equals 0.08, 0.16, and 0.30.

FIG. 33 is a plot of thermoelectric figure of merit (ZT) as a function of temperature for samples of (PbTe_{0.92}S_{0.08})_{1-q}(Na₂Te)_{q} wherein q equals 0.08, 0.16, and 0.30.

FIG. 34 are plots of, clockwise from top left, Seebeck coefficient, electrical resistivity, Hall coefficient, and Nernst coefficient as a function of temperature for Pb_{0.99}Na_{0.01}Te₁₋ₓSₓ (x=0 (X), 0.04 (diamond), 0.08 (triangle), and 0.12 (circle)). The symbols are experimental points; the lines are added to guide the eye. The inset plots Hall resistance as a function of external magnetic field at selected temperatures for x=0.08.

FIG. 35 is a plot of fractional Hall coefficient as a function of temperature for Pb_{0.99}Na_{0.01}Te₁₋ₓSₓ (x=0 (X), 0.04 (diamond), 0.08 (triangle), and 0.12 (circle)). The inset includes x=0.08 to an extended temperature range.

FIG. 36 is a plot of Seebeck coefficient from 2-240K as a function of temperature for Pb_{0.99}Na_{0.01}Te₁₋ₓSₓ (x=0, 0.04, 0.08, and 0.12). The top plot includes x=0 and x=0.12 in 0 and 7 T field. The bottom plot includes x=0.04 in 0, 3.5 T, and 7 T field. The inset is a zoomed in view of the bottom plot.

FIG. 37 is a plot of electrical resistivity and Hall coefficient for Pb_{0.99}Na_{0.01}Te₁₋ₓSₓ (x=0 (X), 0.04 (diamond), and 0.12 (circle)) from 2-240K.

FIG. 38 is a plot of high temperature Seebeck coefficient, electrical resistivity, and power factor as a function of temperature for Pb_{0.99}Na_{0.01}Te₁₋ₓSₓ (x=0.08 (triangle) and 0.12 (circle)).

FIG. 39 is a plot of thermal conductivity and zT as a function of temperature for Pb_{0.99}Na_{0.01}Te₁₋ₓSₓ (x=0 (X), 0.08 (triangle) and 0.12 (circle)).

FIG. 40 are plots of electrical conductivity, thermopower, and power factor as a function of temperature for (PbTe)_{0.98-x}(PbS)ₓ(NaTe)_{0.02} wherein x=0, 0.04, 0.08, 0.12, 0.16, 0.30, and 1.00.

FIG. 41 is a plot of thermal conductivity as a function of temperature for (PbTe)_{0.98-x}(PbS)ₓ(NaTe)_{0.02} wherein x=0, 0.04, 0.08, 0.12, 0.16, 0.30, and 1.00.

FIG. 42 is a plot of ZT as a function of temperature for (PbTe)_{0.98-x}(PbS)ₓ(NaTe)_{0.02} wherein x=0, 0.04, 0.08, 0.12, 0.16, 0.30, and 1.00.

FIG. 43 are plots of electrical conductivity, thermopower, power factor, and ZT as a function of temperature for (PbTe)_{0.88}(PbS)_{0.12} with sodium doping concentration of 0.5%, 1%, 1.5%, and 2% by atomic concentration.

FIG. 44 are plots of thermal conductivity and ZT as a function of temperature for PbTe without sodium doping and (PbTe)_{0.88}(PbS)_{0.12} with sodium doping concentration of 2% by atomic concentration.

FIG. 45 is a plot of measured electrical conductivity as a function of temperature for samples of Pb_{0.9875-z}K_{0.0125}Na_{z}Te wherein z equals 0.004, 0.006, 0.008, 0.01, 0.012, 0.014, and 0.016.

FIG. 46 is a plot of measured Seebeck coefficient as a function of temperature for samples of Pb_{0.9875-z}K_{0.0125}Na_{z}Te wherein z equals 0.004, 0.006, 0.008, 0.01, 0.012, 0.014, and 0.016.

FIG. 47 is a plot of the power factor as a function of temperature for samples of Pb_{0.9875-z}K_{0.0125}Na_{z}Te wherein z equals 0.004, 0.006, 0.008, 0.01, 0.012, 0.014, and 0.016.

FIG. 48 is a plot of measured total thermal conductivity as a function of temperature for samples of Pb_{0.9875-z}K_{0.0125}Na_{z}Te wherein z equals 0.004, 0.006, 0.008, 0.01, 0.012, 0.014, and 0.016.

FIG. 49 is a plot of thermoelectric figure of merit (ZT) as a function of temperature for samples of Pb_{0.9875-z}K_{0.0125}Na_{z}Te wherein z equals 0.004, 0.006, 0.008, 0.01, 0.012, 0.014, and 0.016.

FIG. 50 is a plot of measured electrical conductivity as a function of temperature for samples of Pb₁₋ᵤKᵤTe_{0.92}S_{0.08} wherein u equals 0.005, 0.01, 0.015, and 0.03.

FIG. 51 is a plot of measured total thermal conductivity as a function of temperature for samples of Pb₁₋ᵤKᵤTe_{0.92}S_{0.08} wherein u equals 0.005, 0.01, 0.015, and 0.03.

FIG. 52 is a plot of measured Seebeck coefficient as a function of temperature for samples of Pb₁₋ᵤKᵤTe_{0.92}S_{0.08} wherein u equals 0.005, 0.01, 0.015, and 0.03.

FIG. 53 is a plot of measured lattice thermal conductivity as a function of temperature for samples of Pb₁₋ᵤKᵤTe_{0.92}S_{0.08} wherein u equals 0.005, 0.01, 0.015, and 0.03.

FIG. 54 is a transmission electron microscope image of a Pb_{0.9875}TeK_{0.0125} sample.

FIG. 55 is a transmission electron microscope image of a Pb_{0.9815}TeNa_{0.006}K_{0.0125} sample.

FIG. 56 is a plot of measured Seebeck coefficient as a function of carrier density at a temperature of 300 K for samples of SnTe doped with 1 atomic % In or 2.5 atomic % In along with reported data for SnTe without being doped with indium.

### DETAILED DESCRIPTION

Using Equation 2, measuring the Seebeck coefficient and the carrier density of the semiconductor doped with an impurity that may form a resonant state, and comparing that measurement to the Pisarenko relation valid for the parent semiconductor, constitutes a straightforward test for detecting resonance (Joseph P. Heremans, Vladimir Jovovic, Eric S. Toberer, Ali Saramat, Ken Kurosaki, Anek Charoenphakdee, Shinsuke Yamanaka, and G. Jeffrey Snyder, “Enhancement of Thermoelectric Efficiency in PbTe by Distortion of the Electronic Density of States,” Science, Vol. 321, pp. 554-558 (2008), incorporated herein in its entirety by reference).

A recent study (V. Jovovic, S. J. Thiagarajan, J. P. Heremans, T. Komissarova, D. Khokhlov, and A. Nicorici, “Low temperature thermal, thermoelectric and thermomagnetic transport in indium rich Pb₁₋ₓSnₓTe alloys” J. Appl. Phys., Vol. 103, pp. 053710, 1-7 (2008), incorporated herein in its entirety by reference), of a series of indium-doped PbTe samples confirms the result of the literature to date using thermoelectric and thermomagnetic measurements at 77 K. Recently, these measurements have been extended to 400 K (V. Jovovic, S. J. Thiagarajan, J. P. Heremans, T. Komissarova, D. Khokhlov, and A. Nicorici, “High-Temperature Thermoelectric Properties of Pb₁₋ₓSnₓTe:In” Mater. Res. Soc. Symp. Proc., Vol. 1044, pp. U04-09, Warrendale, Pa. (2008), incorporated herein in its entirety by reference), and these measurements lead to the conclusion that the Fermi level, and thus the indium level, crosses into the energy gap at around 300 K, rendering the pinning effect on the Fermi level to be nil. At temperatures of 300 K or higher, the indium level does not contribute to the Seebeck coefficient or ZT.

In an investigation of the infrared absorption properties of thallium-doped PbTe, a similar pinning effect was reported (N. Veis, S. A. Nemov, V. A. Polovinkin and Yu. I. Ukhanov, Sov. Phys. Semicond., Vol. 11, pp. 588 (1977)) where the Fermi level is pinned in the valence band, and at a deeper level (100 meV below the top of the valence band). Such results raise the possibility that the temperature coefficient of thallium-doped PbTe may either have the opposite sign as does the temperature coefficient of indium-doped PbTe and the impurity level might actually sink deeper into the valence band, or that at least the temperature at which the impurity level crosses into the gap might be raised. Contrary to certain embodiments described herein, Kaidanov et al. (V. I. Kaidanov, S. A. Nemov, R. B. Melnik, A. M. Zaitzev and O. V. Zhukov, Sov. Phys. Semicond, Vol. 20, pp. 541 (1986)) reported an observation of a Seebeck coefficient of 120 μV/K at 300 K at a carrier concentration of p=1.16×10¹⁹ cm⁻³. Such a Seebeck coefficient is practically on the known curve for non-doped PbTe (e.g., 125 μV/K).

Without being bound by theory, certain embodiments described herein utilize a significantly higher thallium doping level to achieve an advantageous feature of the density of states near (e.g., within kT of) the Fermi level in thallium-doped PbTe. For example, as described more fully below, the energy derivative of the density of states can have one or more maxima or peaks, and the Fermi level of the compound can be located within kT of one of the maxima or peaks. In certain embodiments, at least one of gallium, aluminum, zinc, and cadmium can also be used to dope PbTe to have similar behavior (impurity resonance levels for thallium, gallium, zinc, and cadmium in PbTe have previously been calculated (S. Ahmad, S. D. Mahanti, K. Hoang and M G. Kanatzidis, Phys. Rev. B, Vol. 74, pp. 155205 (2006))).

Certain embodiments described herein provide a thermoelectric device comprising a doped compound semiconductor of at least one Group IV element (e.g., Si, Ge, Sn, or Pb) and at least one Group VI element (e.g., O, S, Se, or Te). The compound may be a doped intermetallic compound semiconductor. For example, the compound can be doped with at least one dopant selected from the group consisting of indium, thallium, gallium, aluminum, and chromium.

In certain embodiments, the at least one Group VI element comprises at least two elements selected from the group consisting of: tellurium, selenium, and sulfur. For example, the compound may have a general composition of PbTe₁₋ₓSeₓ, with x between 0.01 and 0.99, between 0.05 and 0.99, between 0.01 and 0.5, or between 0.05 and 0.5. In certain such embodiments, the at least one Group IV element comprises lead and at least one element selected from the group consisting of: germanium and tin. For example, the compound may have at least one compound having a general composition selected from the group consisting of: Pb_{1-y}Sn_{y}SeₓTe₁₋ₓ, Pb_{1-y}Sn_{y}SₓTe₁₋ₓ, Pb_{1-y}Sn_{y}SₓSe₁₋ₓ, Pb_{1-y}Ge_{y}SeₓTe₁₋ₓ, Pb_{1-y}Ge_{y}SₓTe₁₋ₓ, Pb_{1-y}Ge_{y}SₓS₁₋ₓ, where x is between 0.01 and 0.99, between 0.05 and 0.99, between 0.01 and 0.5, or between 0.05 and 0.5, and y is between 0.01 and 0.99, between 0.05 and 0.99, between 0.01 and 0.5, or between 0.05 and 0.5. In certain embodiments, the at least one dopant is selected from the group consisting of: at least one Group IIa element, at least one Group IIb element, at least one Group IIa element, at least one Group IIIb element, at least one lanthanide element, and chromium. The compound may have a thermoelectric figure of merit, ZT (=TS²σ/κ), greater than 0.7 at temperatures greater than 500K. In certain embodiment, the at least one Group IV element is on a first sublattice of sites and the at least one Group VI element is on a second sublattice of sites, wherein the at least one Group IV element comprises at least 95% of the first sublattice sites. In certain such embodiments, the first sublattice is a metal sublattice which comprises the sites in which metal atoms reside in a defect-free compound of the at least one Group IV element and the at least one Group VI element. In certain embodiments, the second sublattice comprises the sites in which the at least one Group VI elements reside in a defect-free compound of the at least one Group IV element and the at least one Group VI element.

In certain embodiments, the compound comprises a p-type thermoelectric material with a peak figure of merit value greater than 0.7 at temperatures greater than 500 K, greater than 1.0 at temperatures greater than 580 K, and/or greater than 1.4 at temperatures at temperatures greater than 770 K. In certain other embodiments, the compound comprises an n-type thermoelectric material with a peak figure of merit value greater than 1.1 at temperatures greater than 500 K. The compound may have a peak figure of merit value greater than 1.4 at a temperature greater than 700 K.

In certain embodiments, the compound (e.g., intermetallic compound semiconductor or IV-VI semiconductor compound) has an improved thermoelectric figure of merit by the addition of small amounts (e.g., between about 0.1 atomic % to about 5 atomic %) of one or more dopant elements selected from Group IIa (e.g., Be, Mg, Ca, Sr, and Ba), Group IIb (e.g., Zn, Cd, and Hg), Group IIIa (e.g., Sc, Y, La), Group IIIb (e.g., Al, Ga, In, and Tl), and the lanthanides (e.g., La, Ce, Pr, Nd, Pm, Sm, Eu, Gd, Tb, Dy, Ho, Er, Tm, Yb, Lu). In certain various embodiments, the atomic doping concentration is in a range between about 0.1 atomic % and about 5 atomic %, between about 0.2 atomic % and about 5 atomic %, between about 0.4 atomic % and about 2 atomic %, between about 0.4 atomic % and about 1 atomic %, or between about 0.4 atomic % and about 0.8 atomic %. For example, for a thallium-doped material, the thallium atomic concentration can be in a range between about 0.5 atomic % to about 2 atomic % or in a range between about 0.1 atomic % to about 5 atomic %, either as a substitute for atoms of the at least one Group IV element or in addition to the at least one Group IV element. The dopant elements can be advantageously selected to be elements that create hybridized deep resonant levels in the compound. Certain embodiments provide improved ZT values in various ranges of temperatures depending on the chemical nature of the resonant level induced by the dopant element, and the chemical nature of the host IV-VI semiconductor compound.

In certain embodiments, the compound is doped with two or more dopant elements. For example, at least one first dopant comprises at least one element selected from the group consisting of indium, thallium, gallium, aluminum, and chromium and at least one second dopant comprises at least one element selected from the group consisting of lithium, sodium, iodine, bromine, and silver can be used. In certain such embodiments, the iodine or bromine can be added as PbI₂ or PbBr₂. Ga-doped PbTe can be n-type, and the halogens can be used as n-type dopants for PbTe:Ga. As another example, at least one first dopant comprises at least one element selected from the group consisting of indium, thallium, gallium, aluminum, and chromium and at least one second dopant comprising an excess amount of the at least one Group VI element (e.g., Te, Se, or S) can be used. In certain such embodiments, the atomic concentration of the at least one Group VI element is greater than the atomic concentration of the at least one Group IV element and the excess amount of the at least one Group VI element is equal to a difference between the atomic concentration of the at least one Group VI element and the atomic concentration of the at least one Group IV element.

In certain embodiments, the at least one Group IV element comprises lead, the at least one Group VI element comprises tellurium, and the at least one dopant comprises thallium with a dopant concentration in a range between about 0.5 atomic % and about 5 atomic %. In certain embodiments, the at least one Group IV element comprises at least one element selected from the group consisting of lead and tin, the at least one Group VI element comprises tellurium, and the at least one dopant comprises thallium. In certain embodiments, the at least one Group IV element comprises lead, the at least one Group VI element comprises tellurium, and the at least one dopant comprises at least one element selected from the group consisting of thallium and sodium. In certain such embodiments, the thallium concentration is in a range between about 0.5 atomic % and about 5 atomic %, and the sodium concentration is in a range between about 0.5 atomic % and about 5 atomic %. In certain embodiments, the at least one Group IV element comprises lead, the at least one Group VI element comprises tellurium, and the at least one dopant comprises at least one of gallium and one or more additional dopant selected from the group consisting of: a halogen (e.g., chlorine, iodine, and bromine), bismuth, and antimony. In certain such embodiments, the gallium concentration is in a range between about 0.5 atomic % and about 5 atomic %, and the halogen concentration is in a range between about 0.5 atomic % and about 5 atomic %. In some embodiments (e.g., for PbTe:Ga or PbTe:Al), the double doping of either Ga or Al with a halogen, bismuth, or antimony advantageously provides an n-type material. For PbTe:Ga, Volkov et al. (B. A. Volkov, L. I. Ryabova, and D. R. Khokhlov, Physics-Uspekhi, Vol. 45, pp. 819 (2002)), describes that there are two saturation regions: one with a low electron density, and one at a higher electron density. Certain embodiments described herein are in the higher electron density regime, which is achieved by adding iodine, bromine, bismuth, or antimony as an n-type dopant. In certain embodiments in which the dopant element comprises gallium (e.g., for PbTe doped with gallium), the atomic concentration of the Group IV-Group VI compound deviates toward the Group IV-rich side, with Group IV atomic concentration greater than the Group VI atomic concentration by an amount in the range between about 0.1 atomic % to about 0.5 atomic %. In certain such embodiments, the Ga-doped, Pb-rich PbTe is advantageously used as an n-type thermoelectric material with improved ZT.

In certain embodiments, the compound comprises a first atomic concentration of the at least one Group IV element and a second atomic concentration of the at least one Group VI element, and the first atomic concentration and the second atomic concentration are within about 2% of one another (e.g., either Group IV- or metal-rich or Group VI- or chalcogen-rich). In certain embodiments, the compound comprises a first atomic concentration of the at least one Group IV element and a second atomic concentration of the at least one Group VI element, and the first atomic concentration is less than the second atomic concentration.

In certain embodiments, the at least one dopant further comprises at least one metal element. For example, the at least one metal element comprises at least one of at least one alkali metal element (e.g., lithium, sodium, potassium, rubidium, and cesium) and at least one noble metal element (e.g., silver, copper, and gold).

In certain embodiments, a thermoelectric device comprises a doped Group IV chalcogenide compound doped with at least one dopant such that a resonant level is formed in an energy band of the compound and the Fermi level of the compound is at an energy within kT of the resonant level. For example, the doped Group IV chalcogenide compound comprises at least one Group IV element selected from the group consisting of lead, tin, germanium, and silicon. In certain embodiments, the doped Group IV chalcogenide compound comprises at least one Group VI chalcogen selected from the group consisting of tellurium, selenium, sulfur, and oxygen.

In a previous study by Kaidanov et al. (V. I. Kaidanov, E. K. Iordanishvili, V. N. Naumov, S. A. Nemov and Yu. I. Ravich, Sov. Phys. Semicond., Vol. 20, pp. 693-694 (1986)), PbTe double-doped with both thallium and sodium was observed to have an increased thermoelectric power. The Seebeck coefficient was observed to reach up to 140 μV/K, a three-to-four-fold improvement over the performance of PbTe doped to similar carrier densities with sodium alone. This result was achieved while decreasing the electrical conductivity of the material only by a factor of 2. In certain embodiments described herein, a major constituent of the at least one Group IV element is not lead (e.g., lead is less than 5% of the at least one Group IV element, or lead is less than 2% of the at least one Group IV element). In certain other embodiments, a major constituent of the at least one Group VI element is not tellurium (e.g., tellurium is less than 5% of the at least one Group VI element, or tellurium is less than 2% of the at least one Group VI element). In certain other embodiments, the thermoelectric material is not appreciably doped with sodium.

These results were attributed by Kaidanov et al. to be the result of a phenomenon they called “resonant scattering”. In a subsequent paper, Kaidanov et al. (V. I. Kaidanov, S. A. Nemov and Yu. I. Ravich, Sov. Phys. Semicond., Vol. 26, pp. 113 (1992)) stated explicitly that such double-doping is necessary to increase ZT. A subsequent review article by Ravich (Y. I. Ravich, “Selective Carrier Scattering in Thermoelectric Materials”, Chapter 7, pp. 67-81, in CRC Handbook of Thermoelectrics, D. M. Rowe, editor, CRC Press, Boca-Raton Fla., 1995) repeats that adding both thallium and sodium at 1% levels in PbTe is necessary to increase the thermoelectric figure of merit ZT. These statements by Kaidanov et al. and Ravich are based on the effect of increasing the energy dependence of the relaxation time, and thus the second term, or mobility term dμ/dE, in the Mott relation as expressed by equation (2). The mobility term dμ/dE is dependent on temperature. This concept leads Ravich to explicitly teach (see, page 70 of Ravich) that such a mechanism is only effective at low temperatures, where phonon-electron scattering is less effective, and thus “resonant scattering” is relatively more effective. Additionally, this concept has led the prior literature to concentrate on improving ZT below room temperature using this mechanism.

In contrast, without being bound by theory, certain embodiments described herein utilize the first term of the Mott relation, as expressed by equation (2), dn/dE to advantageously provide compounds having a temperature-independent improvement of their thermoelectric properties. In some embodiments, dn/dE at or near (e.g., within kT of) the Fermi level is advantageously maximized. In addition, certain embodiments described herein provide a much improved peak ZT (e.g., greater than 0.7) at temperatures above room temperature (e.g., above 300 K) or higher (e.g., above 500 K) since the Seebeck coefficient of degenerately-doped semiconductors is proportional to temperature.

Contrary to the explicit teachings of Ravich, certain embodiments described herein do not utilize double-doping with thallium and sodium. Certain such embodiments utilize p-type thallium-doped PbTe, without double-doping with Na, to provide large improvements in ZT at temperatures significantly above room temperatures. To improve ZT by doping the PbTe compound with a single dopant element, it is desirable to have both a hybridized level and an appropriate hole density. Thallium is a known acceptor in PbTe, and a hybridized level is created spontaneously, in contradiction to the teachings of the cited literature, provided that the thallium impurity is added in an appropriate concentration. This concentration (e.g., on the order of about 0.1 atomic % to about 2 atomic %) depends on the stoichiometry of the parent material (e.g., the ratio of metal Pb to chalcogen Te for PbTe), and in certain embodiments, the concentration range can be broadened by adding extra tellurium.

In certain embodiments, compounds doped with gallium provide n-type IV-VI thermoelectric materials with improved ZT. In certain such embodiments, the stoichiometry of the parent IV-VI compound is advantageously adjusted. For example, for PbTe doped with gallium, the parent compound can be made slightly Pb-rich (e.g., with an additional Pb concentration on the order of 2×10¹⁹ to 1×10²⁰ cm⁻³) (see, e.g., G. S. Bushmarina, B. F. Gruzinov, I. A. Drabkin, E. Ya. Lev and I. V. Nelson, Sov. Phys. Semicond. 11 1098 (1978)).

In certain embodiments, nano-scale thermoelectric materials comprising semiconductor compounds with charge carriers at or near (e.g., within kT of) hybridized energy levels are provided. Resonant scattering is known to limit the electron mobility in tellurium-doped PbTe to values below perhaps 100 cm²/Vs (V. I. Kaidanov, S. A. Nemov and Yu. I. Ravich, Sov. Phys. Semicond., Vol. 26, pp. 113 (1992). Consequently, the electron mean free path in such materials is already very short (e.g., on the order of a few interatomic spacings, or 1-2 nanometers). This conclusion is likely generalized to all semiconductors in which the carriers are in or close to (e.g., within kT of) a strong distortion of the density of states, such as induced by hybridized resonant levels. Preparing the thermoelectric material in the form of nanometer-sized grains, sintered or otherwise attached together, which might scatter these electrons, is not likely to decrease the mobility much further. However, such a morphology will scatter the phonons responsible for the lattice thermal conductivity, resulting in a strong decrease in thermal conductivity without the concomitant deleterious effect on the electrical conductivity. In certain embodiments, the thermal conductivity is reduced by about one-third (see, e.g., F. Ioffe, Physics of Semiconductors (Academic Press, New York, 1960)). Therefore, semiconductor compounds with charge carriers at or near hybridized resonant energy levels and in which resonant scattering such as described by Kaidanov et al. and Ravich is effective, are prime candidates for being prepared as nano-scale thermoelectric materials (e.g., with grains or particles having dimensions in a range between about 1 nanometer and about 100 nanometers).

Like nanoparticles scattering above, alloy scattering is known to reduce the mean free path of both electrons and phonons (see, e.g., B. Abeles, Phys Rev., Vol. 131, pp. 1906 (1963)). Since the mean free path of electrons near a resonant level is already short, alloy scattering will not shorten it much more, but it will very effectively scatter phonons. In certain embodiments, the thermoelectric material has alloy scattering.

In certain embodiments, a thermoelectric material includes at least one compound that comprises, consists, or consists essentially of a general composition of Pb_{w-y-z-u}Te₁₋ₓSₓNa_{z}KᵤTl_{y}, wherein w>y+z+u, 0≦x≦0.30, 0≦z≦0.05, 0≦u≦0.05, 0≦y≦0.05, and at least one of z, u, and y is greater than zero. The units of components u, w, x, y, and z are in atomic fractions. In further embodiments, at least two of z, u, and y are greater than zero, or z, u, and y are all greater than zero. In some embodiments, the at least one compound is p-type, and in other embodiments, the at least one compound is n-type.

In further embodiments, the thermoelectric material has components in the range of 0<z≦0.05, the range of 0<u≦0.05, the range of 0<y≦0.05, the ranges of 0<z≦0.05 and 0<u≦0.05, the ranges of 0<z≦0.05 and 0<y≦0.05, the ranges of 0<u≦0.05 and 0<y≦0.05, or the ranges of 0<z≦0.05, 0<u≦0.05, and 0<y≦0.05. In some embodiments, the thermoelectric material has components in the ranges of 0.001≦z≦0.05, the range of 0.01≦z≦0.03, or the range of 0.004≦z≦0.014. In certain embodiments, the thermoelectric material has components in the range of 0.005≦z≦0.02, the range of 0.005≦u≦0.02, the range of 0.005≦y≦0.02, the ranges of 0.005≦z≦0.02 and 0.005≦u≦0.02, the ranges of 0.005≦z≦0.02 and 0.005≦y≦0.02, the ranges of 0.005≦u≦0.02 and 0.005≦y≦0.02, or the ranges of 0.005≦z≦0.02, 0.005≦u≦0.02, and 0.005≦y≦0.02. In certain embodiments, the thermoelectric material has components in the range of 0.01≦z≦0.03, the range of 0.01≦u≦0.03, the range of 0.01≦y≦0.03, the ranges of 0.01≦z≦0.03 and 0.01≦u≦0.03, the ranges of 0.01≦z≦0.03 and 0.01≦y≦0.03, the ranges of 0.01≦u≦0.03 and 0.01≦y≦0.03, or the ranges of 0.01≦z≦0.03, 0.01≦u≦0.03, and 0.01≦y≦0.03. In further embodiments, the thermoelectric material has components in the ranges of 0<y+z+u≦0.05, the range of 0.01≦y+z+u≦0.03, or the range of 0.005≦y+z+u≦0.02.

In certain embodiments, the thermoelectric material has components in the ranges of 0<x≦0.30, the range of 0.02≦x≦0.30, the range of 0.08≦x≦0.30, the range of 0.08≦x≦0.12, or the range of 0.04≦x≦0.16. In further embodiments, the thermoelectric material has components in the ranges of 0.94≦w≦1.06 or the range of 0.94≦w−y−z−u≦1.06. In other embodiments, the thermoelectric material has components in the ranges of 0.96≦w≦1.04 or the range of 0.96≦w−y−z−u≦1.04. In one embodiment, the at least one compound has a general composition of Pb_{1-y-z}Tl_{y}Na_{z}Te₁₋ₓSₓ wherein 0.0<y<0.05, 0.001<z<0.05, and 0.02<x<0.3 mole fraction. In further embodiments, the thermoelectric material has components in the ranges of 0.04<x<0.16.

In certain embodiments, a thermoelectric material comprises at least one compound having a general composition of Pb_{w-z}Te₁₋ₓSₓNa_{z}, wherein w>z, 0<x≦0.30, 0<z≦0.05, wherein Pb is lead, Te is tellurium, and Na is sodium. In other embodiments, a thermoelectric material comprises at least one compound having a general composition of Pb_{w-u}Te₁₋ₓSₓKᵤ, wherein w>u, 0<x≦0.30, 0<u≦0.05, wherein Pb is lead, Te is tellurium, and K is potassium. In further embodiments, a thermoelectric material comprises at least one compound having a general composition of Pb_{w-y}Te₁₋ₓSₓTl_{y}, wherein w>y, 0<x≦0.30, 0<y≦0.05, wherein Pb is lead, Te is tellurium, and Tl is thallium. In even further embodiments, a thermoelectric material comprising at least one compound having a general composition of Pb_{w-z-u}Te₁Na_{z}Kᵤ, wherein w>z+u, 0<x≦0.30, 0<z≦0.05, 0<u≦0.05, wherein Pb is lead, Te is tellurium, Na is sodium, and K is potassium.

In certain embodiments, a thermoelectric material includes at least one compound that comprises, consists, or consists essentially of a general composition of A_{w-t}Te₁₋ₓSₓDₜ, wherein w>t, 0≦x≦0.30, 0<t≦0.05, wherein A is selected from the group consisting of lead and tin, Te is tellurium, S is sulfur, and D is selected from the group consisting of sodium, potassium, and thallium. The units of components w, x, and t are in atomic fractions. In some embodiments, the at least one compound is p-type, and in other embodiments, the at least one compound is n-type.

In certain embodiments, the thermoelectric material has components in the ranges of 0.001≦t≦0.05, the range of 0.01≦t≦0.03, or the range of 0.005≦t≦0.02. Component D may include any combination of sodium, potassium, and thallium in various concentration ranges. For example, D may consist of sodium, D may consist of potassium, D may consist of thallium, D may consist of sodium and potassium, D may consist of sodium and thallium, D may consist of potassium and thallium, or D may consist of sodium, potassium, and thallium. In some embodiments, if sodium, potassium, or thallium is present, each element that is present accounts for at least 10 atomic % of D. For example, in one embodiment where D consists of sodium and potassium, at least 10 atomic % of D is sodium and at least 10 atomic % of D is potassium. Furthermore, D may include equivalent ranges of concentrations of sodium, potassium, and thallium described above with regard to components y, u, and z.

In some embodiments, the thermoelectric material has components in the ranges of 0<x≦0.30, the range of 0.02≦x≦0.30, the range of 0.08≦x≦0.30, the range of 0.08≦x≦0.12, or the range of 0.04≦x≦0.16. In further embodiments, the thermoelectric material has components in the ranges of 0.94≦w≦1.06 or the range of 0.94≦w−t≦1.06. In other embodiments, the thermoelectric material has components in the ranges of 0.96≦w≦1.04 or the range of 0.96≦w−t≦1.04.

Component A may include any combination of tellurium and tin in various concentration ranges. For example, A may consist of tellurium, A may consist of tin, or A may consist of tellurium and tin. In some embodiments, less than about 5 atomic % of A is lead. In other embodiments, less than about 5 atomic % of A is tin. In certain embodiments, the at least one compound includes less than about 5 atomic % lead. In other embodiments, the at least one compound includes less than about 5 atomic % tin. In further embodiments, the at least one compound includes substantially no lead, while in other embodiments, the at least one compound includes substantially no tin.

In some embodiments, some of the tellurium is substituted for selenium similar to how, in some embodiments described above, some of the tellurium is substituted for sulfur. For example, the at least one compound may have a general composition that further includes selenium such as A_{w-t}Te_{1-q}Se_{q}Dₜ, wherein 0<q≦1 and Se is selenium. In certain embodiments, the thermoelectric material has components in the ranges of 0<x<1, the range of 0.02≦x≦0.30, the range of 0.08≦x≦0.30, the range of 0.08≦x≦0.12, the range of 0.04≦x≦0.16, or 0.01≦q≦0.05. Furthermore, any of the at least one compounds described herein may include selenium in similar concentrations. In certain embodiments, the at least one compound may have a general composition of A_{w-t}Te₁₋ᵣEᵣDₜ, wherein 0<r≦0.30 and E is selected from the group consisting of sulfur and selenium. The individual concentrations of sulfur and selenium can be any of those described herein. For example, E may comprise, consist essentially of, or consist of sulfur, E may comprise, consist essentially of, or consist of selenium, or E may include a combination of sulfur and selenium. In certain embodiments, the thermoelectric material has components in the range of 0.02≦r≦0.30, the range of 0.08≦r≦0.30, the range of 0.08≦r≦0.12, or the range of 0.04≦r≦0.16. The component A and the component D may include any element described herein and the ranges of w and t may also include any of those described herein. For example, A may be selected from the group consisting of lead and tin, D may be selected from the group consisting of sodium, potassium, and thallium and the components are in the range of w>t and 0<t≦0.05.

In certain embodiments, a thermoelectric material includes at least one compound having a general composition of A_{w-t}Te₁Dₜ, wherein w>t, 0<t≦0.05, wherein A is selected from the group consisting of lead and tin, Te is tellurium, and D consists of indium. In some embodiments, the thermoelectric material has components in the ranges of 0.01<t≦0.05. The at least one compound may further include selenium. For example, a concentration of the selenium in certain embodiments is between about 0.1 and about 5 atomic percent of the at least one compound (e.g., A_{w-t}Te_{1-q}Se_{q}Dₜ, wherein 0.01≦q≦0.05). In some embodiments, the component A consists of or consists essentially of tin. In further embodiments, the at least one compound does not or substantially does not include lead.

In certain embodiments, the at least one compounds described herein may further include indium and/or gallium. For example, the at least one compound may include between about 1 atomic percent and about 5 atomic percent indium, the at least one compound may include between about 1 atomic percent and about 5 atomic percent gallium, or the at least one compound may include between about 1 atomic percent and about 5 atomic percent indium and between about 1 atomic percent and about 5 atomic percent gallium.

In some embodiments, the at least one thermoelectric material includes substantially no impurities, substantially no other elements, and/or substantially no other elements that act as a dopant in the at least one alloy.

The at least one compound may include additional elements. The additional elements may act as a dopant. In certain embodiments, the at least one compound includes tin, indium, and/or gallium. In some embodiments, the at least one compound includes both indium and thallium, both gallium and thallium, or all three of indium, gallium and thallium.

The thermoelectric material can be used in a thermoelectric device. For example, a thermoelectric device can include at least one thermoelectric material described herein. In certain embodiments, at least one portion of the thermoelectric material and/or the at least one compound is exposed to a temperature greater than about 300 K, greater than about 500 K, greater than about 550 K or greater than about 700 K during operation of the thermoelectric device or during use of the thermoelectric material. Furthermore, the at least one compound may have a thermoelectric figure of merit (ZT) greater than about 1 at a temperature of about 550 K or at temperatures between about 550 K and about 700 K.

In one example, a method of using a thermoelectric material may include providing a thermoelectric material comprising at least one compound having a general composition of A_{w-t}Te₁₋ₓSₓDₜ, wherein w>t, 0≦x≦0.30, 0<t≦0.05, wherein A is selected from the group consisting of lead and tin, Te is tellurium, S is sulfur, and D consists of sodium and thallium, and exposing at least one portion of the at least one compound to a temperature greater than about 550 K during use of the thermoelectric material. In some embodiments, the at least one compound has a general composition of Pb_{w-z-y}Te₁₋ₓNa_{z}Tl_{y}, wherein w>z+y, 0<z≦0.05, and 0<y≦0.05, wherein Pb is lead, Te is tellurium, Na is sodium, and Tl is thallium. In certain embodiments, at least one portion of the thermoelectric material and/or the at least one compound is exposed to a temperature greater than about 550 K or greater than about 700 K during operation of the thermoelectric device or during use of the thermoelectric material. Furthermore, the at least one compound may have a thermoelectric figure of merit (ZT) greater than about 1 at a temperature of about 550 K or at temperatures between about 550 K and about 700 K.

In another example, a method of using a thermoelectric material may include providing a thermoelectric material comprising at least one compound having a general composition of A_{w-t}Te₁Dₜ, wherein w>t, 0<t≦0.05, wherein A is selected from the group consisting of lead and tin, Te is tellurium, and D consists of indium, and exposing at least one portion of the at least one compound to a temperature greater than about 500 K during use of the thermoelectric material. In some embodiments, the at least one compound has a general composition of A_{w-t}Te₁Dₜ, wherein w>t, 0<t≦0.05, wherein A consists of tin, Te is tellurium, and D consists of indium. In certain embodiments, at least one portion of the thermoelectric material and/or the at least one compound is exposed to a temperature greater than about 550 K or greater than about 700 K during operation of the thermoelectric device or during use of the thermoelectric material. Furthermore, the at least one compound may have a thermoelectric figure of merit (ZT) greater than about 1 at a temperature of about 550 K or at temperatures between about 550 K and about 700 K.

The compound can have an increased electrical mobility due to the presence of sulfur. In certain embodiments, the at least one compound has a higher electrical mobility with sulfur than without the sulfur. In other embodiment, the at least one compound has a lower electrical mobility with sulfur than without the sulfur.

In certain embodiments, the at least one compound does not show a second phase upon cooling through the liquidus that will appear as an endotherm at 250 or 280° C., or at any temperature where TlₐTe_{b} phases will go through a phase change, as discernable from a Tl—Te phase diagram. In certain embodiments, the thermoelectric material consists of a single phase, or the thermoelectric material does not comprise a second phase. For example, the thermoelectric material may not include a second phase comprising thallium and tellurium.

In certain embodiments, the at least one compound includes a distortion in the density of states by the presence of thallium. The compound can have an increase in Seebeck coefficient at 300 K due to the distortion in the density of states by the presence of Tl in a matrix comprising PbTe.

In further embodiments, a lower valance band (LVB) of the at least one compound is substantially populated with holes. The compound can allow the population of the LVB with holes, which can lead to an increase in the power factor (e.g., a decrease in thermal conductivity when applying the Wiedemann-Franz law), and ultimately an increase in ZT. Without being bound by theory, the population of the LVB with holes can be witnessed by an increase in resistivity and Seebeck coefficient.

The thermoelectric material can include nanostructures. For example, the thermoelectric material can include grains or particles having dimensions in a range between about 1 nanometer and about 100 nanometers. In certain embodiments, the grains or particles may an average largest dimension between about 1 nanometer and about 100 nanometers or between about 1 nanometer and about 10 nanometers. The thermoelectric material can include nanoscale inclusions, nanoscale inhomogeneties, or nanoprecipitates such as those described in U.S. Patent Publication 2006/0272697, incorporated herein in its entirety by reference. In certain embodiments, the thermoelectric material includes nanoscale inclusions comprising Na₂S.

### EXAMPLES

The following examples are provided to demonstrate the benefits of the embodiments of the disclosed thermoelectric materials. These examples are discussed for illustrative purposes and should not be construed to limit the scope of the disclosed embodiments. For example, the embodiments should not be construed to be bound by any theories discussed below. All composition values are in atomic fraction or atomic percentage unless otherwise specified.

### Example

### Tl_{0.01}Pb_{0.99}Te and Tl_{0.02}Pb_{0.98}Te

Sample materials were formulated and their properties measured. This work was described in Joseph P. Heremans, Vladimir Jovovic, Eric S. Toberer, Ali Saramat, Ken Kurosaki, Anek Charoenphakdee, Shinsuke Yamanaka, and G. Jeffrey Snyder, “Enhancement of Thermoelectric Efficiency in PbTe by Distortion of the Electronic Density of States,” Science, Vol. 321, pp. 554-557 (2008), which is incorporated herein in its entirety by reference. Several disk-shaped samples of Tl_{0.01}Pb_{0.99}Te and Tl_{0.02}Pb_{0.98}Te were prepared and mounted for high-temperature measurements (300 to 773 K) of their conductivity (σ and κ), as well as Hall (R_{H}) and Seebeck (S) coefficients; parallelepipedic samples were cut from the disks and mounted for low-temperature measurements (77 K to 400 K) of galvanomagnetic (ρ and R_{H}) and thermomagnetic (S and N, which stands for the isothermal transverse Nernst-Ettingshausen coefficient) properties.

Tl-doped PbTe was made by direct reaction of appropriate amounts of Pb, Te, and Tl₂Te in a fused-silica tube sealed under a vacuum. Each sample was melted at 1273 K for 24 h and lightly shaken to ensure homogeneity of the liquid. Each sample was then furnace cooled to 800 K and annealed for 1 week. The obtained ingot was crushed into fine powder and hot-pressed at 803 K for 2 hours under a flowing 4% H₂—Ar atmosphere. The final form of each polycrystalline sample was a disk with a thickness of about 2 mm and a diameter of about 10 mm. Phase purity was checked by powder X-ray diffraction. No impurity phases were found in the XRD patterns, indicating that substantially all Tl was dissolved in PbTe. The purity of the starting materials was at least about 99.99%. The samples were stable in air at room temperature. Parallelepipeds were cut out of the disks and were typically about 8 mm long with a cross-section of about 1×1 mm². Other methods of processing can also be used such as ball milling and mechanical alloying.

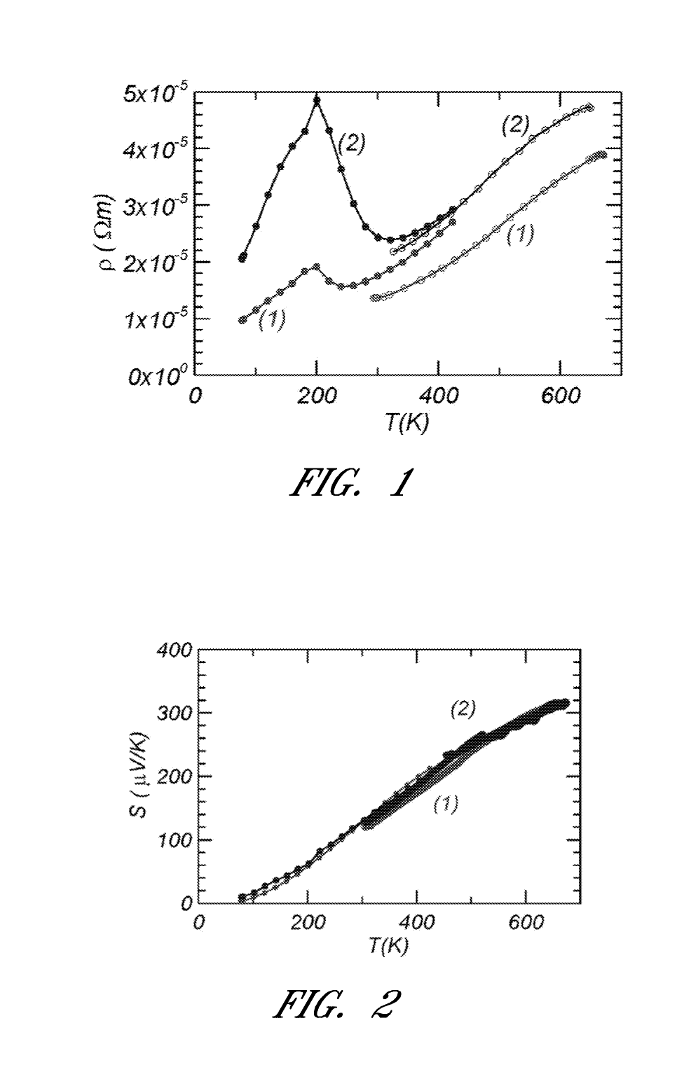

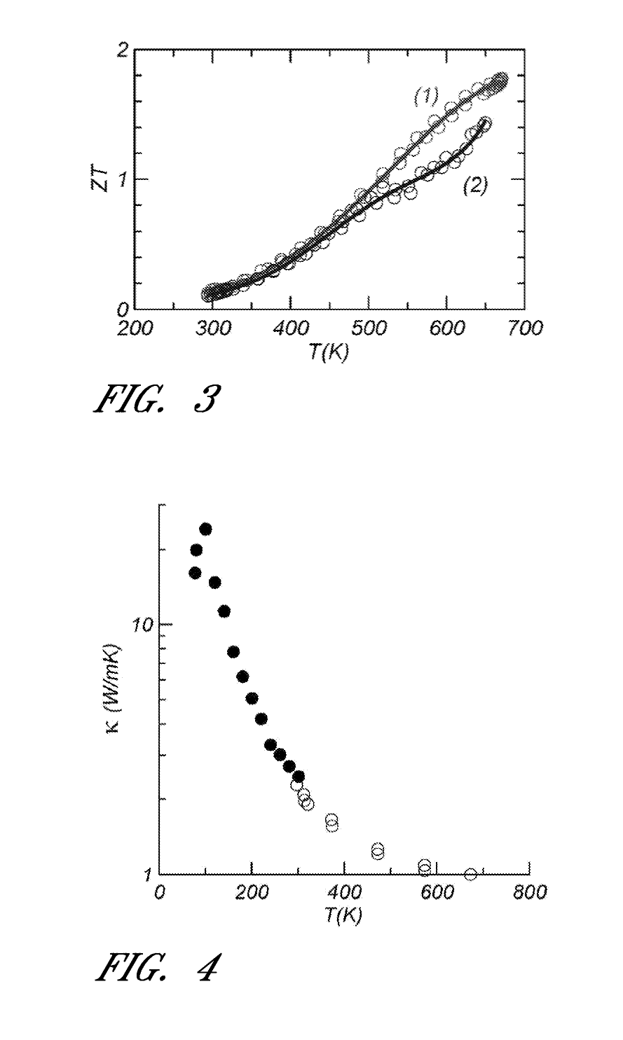

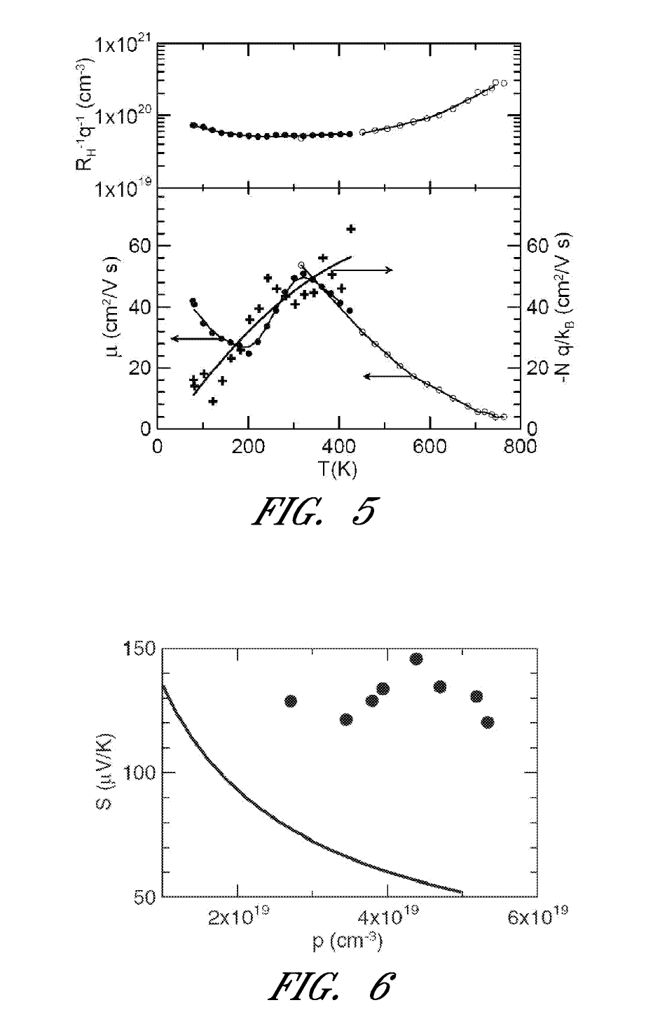

FIG. 1 is a plot of the temperature dependence of the resistivity of thallium-doped lead telluride. The curves labeled (1) are for a sample with 1 atomic % thallium, and the curves labeled (2) are for a sample with 2 atomic % thallium. The open dot curves were taken from 300 to 670 K on disk-shaped samples. The closed dot curves were measured from 77 to 400 K on parallelepiped cut-outs of the disks. FIG. 2 is a plot of the temperature dependence of the Seebeck coefficients of the samples of FIG. 1. FIG. 3 is a plot of the temperature dependence of the calculated figure of merit ZT (=TS²σ/κ) from the data of FIGS. 1 and 2. FIG. 4 is a plot of the temperature dependence of the thermal conductivity of the sample with 2 atomic % thallium. The thermoelectric figure of merit ZT versus temperature shown in FIG. 3 shows a significant improvement as compared to conventional thermoelectric materials (e.g., for temperatures greater than 300 K). For example, at 500 K, both Tl_{0.01}Pb_{0.99}Te and Tl_{0.02}Pb_{0.98}Te have values of ZT greater than 0.7, and the figure of merit, ZT, for both Tl_{0.01}Pb_{0.99}Te and Tl_{0.02}Pb_{0.98}Te increases with increasing temperature from 300 K to at least 650 K. The figure of merit for Tl_{0.01}Pb_{0.99}Te has a peak figure of merit value of about 0.85 at a temperature of about 670 K. The figure of merit for Tl_{0.02}Pb_{0.98}Te does not appear in FIG. 3 to have a peak at temperatures less than 773 K; however, it is expected that the figure of merit for this compound will decrease at some temperature greater than 773 K, so that the compound has a peak figure of merit value of at least 1.5 at a temperature greater than or equal to 773K.

The high-temperature electrical resistivity, ρ, and Hall coefficient, R_{H}, (in a 2T magnetic field) were measured between 300 K and 773 K on the pressed disks using the van der Pauw technique with a current of 0.5 A under dynamic vacuum (similar to the system described by McCormack, J. A. and Fleurial, J. P., Mater. Res. Soc. Symp. Proc., Vol. 234, pp. 135 (1999)). The Seebeck coefficient S=V/ΔT was measured between 300 K and 773 K on the pressed disks using Chromel-Nb thermocouples with the Nb wires used for voltage measurement. The thermocouples were heat sunk to the heaters contacting the sample to minimize heat leaks through the thermocouples. An about constant 10 K temperature difference was maintained with Proportional-Integration-Differentiation control while the system was uniformly heated and cooled at 100K/hr. The absolute Nb voltage was subtracted from the measured voltage. The Chromel-Nb Seebeck coefficient was derived from measurements of the individual metals compared to Pt. The thermal diffusivity of the disks was measured using a flash diffusivity technique, Netzsch LFA 457. Heat capacity, Cₚ, was estimated using the method of Dulong-Petit with a value of 0.15 J/g·K, which was close to the experimental value from 150 to 270 K (D. H. Parkinson and J. E. Quarrington, Proc. Phys. Soc., Vol. 67, pp. 569 (1954)). The thermal conductivity, κ, was then calculated from the experimental density, heat capacity, and thermal diffusivity. The thermal conductivity of all the samples was about the same and within the experimental errors, and the thermal conductivity of the samples was similar to that of bulk PbTe at similar electrical conductivity (see, e.g., A. D. Stuckes, Br. J. Appl. Phys., Vol. 12, pp. 675 (1961)).

The repeatability of Seebeck, electrical resistivity, and diffusivity measurements as determined from the difference between heating and cooling curves and was within 3 to 5%. The reproducibility, as determined from measurements using different contacts or with different slices from the same pellet, is about 10% with larger uncertainty at higher temperatures. From these combined uncertainties, the estimated uncertainty in maximum ZT is about 20%. In the TlₓPb₁₋ₓTe system, different samples measured with maximum ZT values ranging between 1.2 and 1.9, which were consistent with our estimate of maximum ZT=1.5±0.3.

Between 77 K and 400 K, ρ and R_{H} were measured on two parallelepipedic samples with one cut in the plane of the disk and one perpendicular to it, to verify that the samples were isotropic. The measurements were made using a low-frequency AC bridge, and by taking the appropriate average over both polarities of the magnetic field (−1.8 to 1.8 T), which was a procedure appropriate for the rock-salt crystal structure of PbTe, which excludes Umkehr effects. The Hall coefficient was taken as the slope at zero magnetic field of the transverse Hall resistivity with respect to field. The inaccuracy in sample dimensions, particularly in the distance between the longitudinal probes, is the main source of experimental inaccuracy, and the relative error on the electrical resistivity is on the order of 10%. The Hall coefficient depends on the transverse dimension and is accurate within 3%.

Between 77 K and 400 K, the Seebeck, S, and isothermal Nernst-Ettingshausen, N, coefficients were measured on the parallelepipeds using a static heater and sink method. Similar to above, reversing the sign of the magnetic field has no expected Umkehr effects. The Seebeck coefficient does not generally depend on the sample geometry, and measurement accuracy is limited mostly by the sample uniformity to 5%. The adiabatic Nernst-Ettingshausen coefficient was taken as the slope at zero magnetic field of the transverse Nernst thermoelectric power with respect to field, and the isothermal Nernst coefficient, N, was calculated from the adiabatic one (following the procedure described by J. P. Heremans, C. M. Thrush and D. T. Morelli, J. Appl. Phys., Vol. 98, pp. 063703 (2005)). The Nernst data had about 10% accuracy, limited by the longitudinal distance between the temperature probes.

The thermal conductivity was also measured from 77 K to 300 K using a static heater and sink method on two parallellepipedic samples cut from the same disk of Tl_{0.01}Pb_{0.99}Te both in the plane and perpendicularly to the plane of the disk. The thermal conductivity was found to be isotropic, and also corresponded well to that measured by the diffusivity method. The isotropy of the electrical conductivities was also verified experimentally.

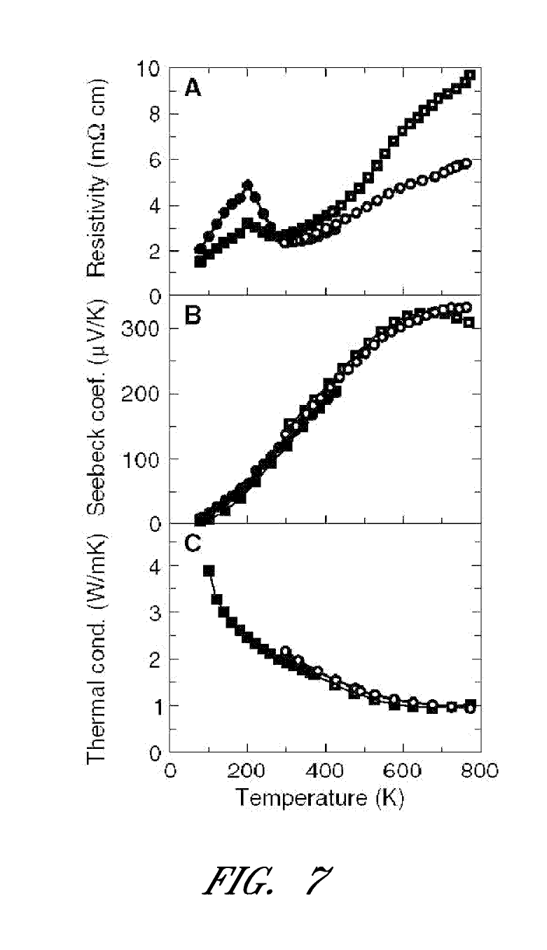

The results for the zero-field transport properties on representative Tl_{0.01}Pb_{0.99}Te and Tl_{0.02}Pb_{0.98}Te samples are shown in the main text. The properties in a transverse magnetic field, the low-field Hall and Nernst coefficients, are shown in FIG. 5. The Hall coefficient is shown in FIG. 5 inverted, R_{H}⁻¹, and in units of hole density. The Nernst coefficient, N, is in units V/K·T and is shown in FIG. 5 divided by the Seebeck coefficient of the free electron, k_{B}/q, where q is the electron charge. In addition, since units of 1/Tesla are those of the mobility, it is represented it in the same units and on the same scale as the Hall mobility.

The “method of the four coefficients”, developed to deduce Hall mobility, μ, scattering exponent, Λ, density of states effective mass, m*_{d}, and the Fermi energy, E_{F}, from measurements of ρ, R_{H}, S and N, has been adapted to degenerately doped semiconductors (see, e.g., V. Jovovic, S. J. Thiagarajan, J. West, J. P. Heremans, T. Story, Z. Golacki, W. Paszkowicz and V. Osinniy, J. Appl. Phys., Vol. 102, pp. 043707 1-6 (2007)). The different materials parameters μ, Λ, m*_{d} and E_{F} have different sensitivities to the different thermomagnetic transport coefficients ρ, R_{H}, S and N. The conclusions presented are quite independent of the band model used. No integrations have to be performed over assumed band structures or dispersion relations, and Bethe-Sommerfeld expansions of the transport properties are analytically solvable for μ, Λ, m*_{d} and E_{F} at the Fermi energy. No numerical manipulations are required in this case.

At temperatures below 450 K, the R_{H} coefficient directly gives the carrier density via n=1/(R_{H}q), and the ratio of Hall coefficient over resistivity gives the mobility μ=R_{H}/ρ as shown in FIG. 5. At temperatures above 500 K, the Hall coefficient decreases with increasing temperature. The reason for this is the onset of two-carrier conduction. Thermally induced minority electrons have a partial Hall coefficient that has the opposite polarity of the partial Hall coefficient of the holes. Therefore, the carrier density above 450K can not be calculated using the above relationship. Generally, the Seebeck coefficient is practically not affected by the partial Seebeck of the minority electron. Equations that include two-carrier conduction (see, e.g., E. H. Putley The Hall Effect and Semiconductor Physics, Dover Publications, New York (1968)) illustrate this effect. While the total Seebeck coefficient is the average of the partial Seebeck coefficients of electrons and holes weighted by their partial electrical conductivities, the total Hall coefficient is weighted by electron and hole mobility square. The electron mobility is on the order of 550 cm²/Vs at 300K, which is larger than the hole mobility as shown in FIG. 5. Therefore, the Hall coefficient is more sensitive to minority carriers than the Seebeck coefficient.

The scattering exponent, A, is derived from the ratio of the Nernst coefficient to the mobility as shown in FIG. 5. From their comparable magnitude and inverted signs, the scattering exponent, A, varies slightly from about −½ to about zero, which is similar to pure PbTe with acoustic phonon and neutral impurity scattering as the dominant scattering mechanisms. The Fermi energy can then be derived from the Seebeck coefficient. From the Fermi energy and carrier density, the local density of states g_{eff}(E_{F}) or the density of states effective mass m*_{d} defined by the relation g_{eff}=4×2×(2πm*_{d})^{3/2}/h³ where the initial factor of 4 represents the number of degenerate hole pockets that constitute the Fermi surface of heavily doped PbTe, and h is Planck's constant, can be calculated. The effective mass can be used to characterize a dispersion relation between the energy, E, and the wave number, k, of a carrier that is parabolic because the effective mass is constant with respect to energy. Since a distorted band is characterized in the case of Tl_{0.02}Pb_{0.98}Te and of Tl_{0.01}Pb_{0.99}Te, m*_{d} is used as a parameterization of the local density of states at the Fermi level, and used to quantify the relative increase of the density of states of Tl—PbTe when compared to that of pure PbTe.

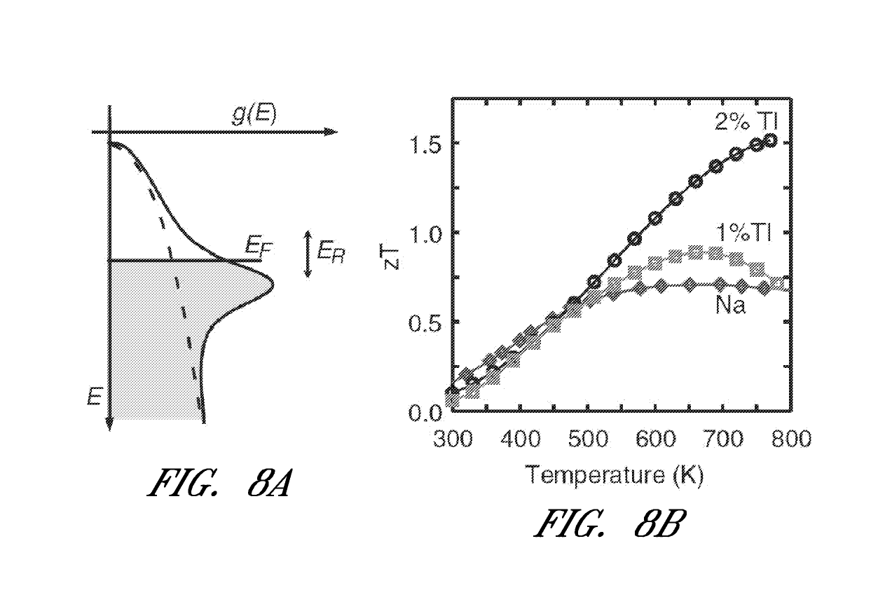

FIG. 6 is a plot of the Seebeck coefficient versus carrier density at a temperature of 300 K, with the value for the sample measured so far shown as the circle datapoints and the Pisarenko curve valid for conventionally doped PbTe shown as the solid curve. FIG. 6 indicates that the enhanced thermoelectric properties are due to a substantial increase of the Seebeck coefficient at the carrier concentration measured from the sample over that of the Pisarenko curve valid for conventionally doped PbTe.

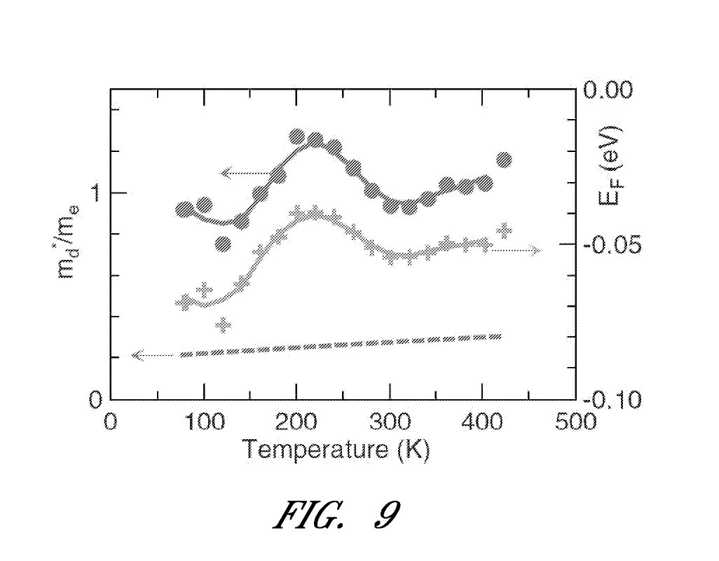

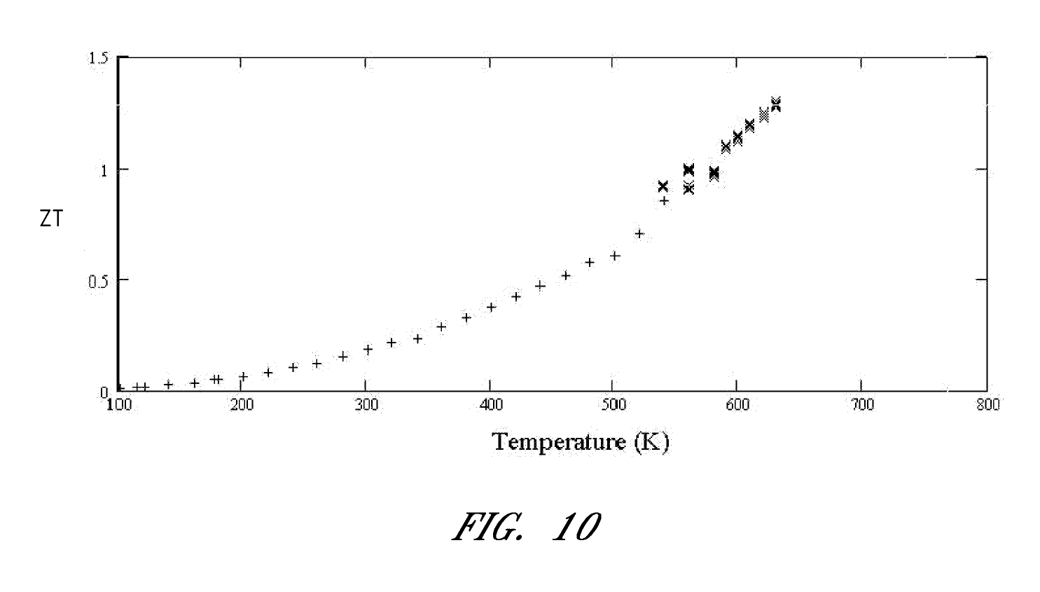

Further results for the zero-field transport properties (i.e., electrical resistivity, Seebeck coefficient, and thermal conductivity) measured on representative samples of Tl_{0.01}Pb_{0.99}Te and Tl_{0.02}Pb_{0.98}Te are shown in FIG. 7. Values of ZT for Tl_{0.02}Pb_{0.98}Te reach 1.5 at 773 K as shown in FIG. 8B. The high value of ZT observed is quite reproducible and robust with respect to slight variation in dopant concentration in Tl_{0.02}Pb_{0.98}Te. The uncertainty in ZT is estimated to be on the order of 7% near room temperature and increasing at higher temperature, assuming that the inaccuracies on S, σ and κ are independent of each other. For Tl_{0.01}Pb_{0.99}Te, the decreased doping levels lead to a lower carrier concentration and a corresponding increase in S and ρ. The values in FIG. 8B represent a 100% improvement of the ZT compared with the best conventional p-type PbTe-based alloys (ZTₘₐₓ=0.71 for Na_{0.01}Pb_{0.99}Te, see, e.g., R. W. Fritts, in Thermoelectric Materials and Devices, I. B. Cadoff, E. Miller, Eds. (Reinhold, New York, 1960), pp. 143-162). The maximum in ZT in certain embodiments occurs at the temperature where thermal excitations start creating minority carriers. This maximum is not reached by 773 K for Tl_{0.02}Pb_{0.98}Te, and thus, in certain embodiments, higher values of ZT may be expected.

The temperature range where these PbTe based materials of certain embodiments exhibit high ZT values (500 to 773 K) is appealing for power generation from waste heat sources such as automobile exhaust. These measurements did not include direct thermoelectric efficiency measurements because of the nontrivial conditions for a matching n-type material, good thermal isolation, and low thermal and electrical contact resistance. The latter consideration arises because the main flow of heat and of electrical current generally passes through the contacts of a TE power generator, in contrast to the situation in the experiments reported here.

The measured κ values of Tl—PbTe samples reproduce that of pure bulk PbTe (Yu. I. Ravich et al., Semiconducting Lead Chalcogenides (Plenum, New York, 1970)). In contrast, ZT-enhancing mechanisms used previously in PbTe-based materials have relied on minimizing the lattice thermal conductivity (G. J. Snyder, E. S. Toberer, Nat. Mater., Vol. 7, pp. 105 (2008); K. F. Hsu et al., Science, Vol. 303, pp. 818 (2004); J. Androulakis et al., Adv. Mater., Vol. 18, pp. 1170 (2006); P. F. R. Poudeu et al., Angew. Chem. Int. Ed., Vol. 45, pp. 3835 (2006)). The slight rise in κ of the Tl_{0.02}Pb_{0.98}Te sample at high temperatures is attributed to ambipolar thermal conduction.

Hall and Nernst coefficients were analyzed to elucidate the physical origin of the enhancement in ZT. The Hall coefficient R_{H} of Tl_{0.02}Pb_{0.98}Te is nearly temperature independent up to 500 K, corresponding to a hole density of 5.3×10¹⁹ cm×⁻³. The room temperature hole mobility μ (μ=R_{H}/ρ) for Tl_{0.02}Pb_{0.98}Te varies from sample to sample between 50 and 80 cm²/Vs and is a factor of 5 to 3 smaller than the mobility of single-crystal PbTe at similar carrier concentrations but has a similar temperature dependence.

Typically S depends strongly on carrier density as shown by Equation 3:

$$S = \frac{8 {π}^{2} {k}_{B}^{2} T}{3 {qh}^{2}} {{m}_{d}^{*} ( \frac{π}{3 n} )}^{\frac{2}{3}} \qquad ( 3 )$$

The solid line of FIG. 6 was calculated given the known band structure and acoustic phonon scattering. It has been previously observed that almost every measurement published on n or p-type bulk PbTe falls on that line (see, e.g., Yu. I. Ravich et al., Semiconducting Lead Chalcogenides (Plenum, New York, 1970)). Compared to this, S of Tl—PbTe at 300 K is enhanced at the same carrier concentration, as shown graphically in FIG. 6, which plots data on every Tl—PbTe sample measured in this study. Each of these samples shows an enhancement in S by a factor of between 1.7 and 3, which, in Tl_{0.02}Pb_{0.98}Te samples, more than compensates for the loss in mobility in ZT. The enhancement increases with carrier density, and indeed so does the ZT.

Referencing Eq. 2, S is a function of the energy dependence of both the density of states and the mobility. The mobility can be represented in terms of a relaxation time τ and a transport effective mass m*:μqτ/m*. The energy dependence of the relaxation time (τ(E)=τ₀E^{Λ}) (Yu. I. Ravich et al., Semiconducting Lead Chalcogenides (Plenum, New York, 1970)) is taken to be a power law, with the power, the scattering exponent L, determined by the dominant electron scattering mechanism. Acoustic phonon scattering in a three-dimensional solid is characterized by Λ=−½.

Nernst coefficient measurements can be used to determine the scattering exponent Λ and to decide which of the two terms in Eq. 2 dominates. The “method of the four coefficients” (J. P. Heremans et al., Phys. Rev. B, Vol. 70, pp. 115334 (2004)) was used to deduce μ, Λ, m*_{d} and E_{F} from measurements of ρ, R_{H}, S, and N. No increase was observed in A over its value (−½) in pure PbTe as would be expected from the “resonant scattering” hypothesis (Yu. I. Ravich, in CRC Handbook of Thermoelectrics, D. M. Rowe, Ed. (CRC Press, Boca Raton, Fla., 1995), pp. 67-81). Furthermore, the effects of resonant scattering would be expected to vanish with increasing temperature, because acoustic and optical phonon scattering would then become ever more dominating. This would not only contradict the results of FIG. 8 but also preclude the use of such materials in any high-temperature applications such as electrical power generators. Thus, the teaching of prior work, such as that of Ravich and Kaidanov would lead to the conclusion that compounds in accordance with certain embodiments described herein would not provide high figure of merit at high temperature.

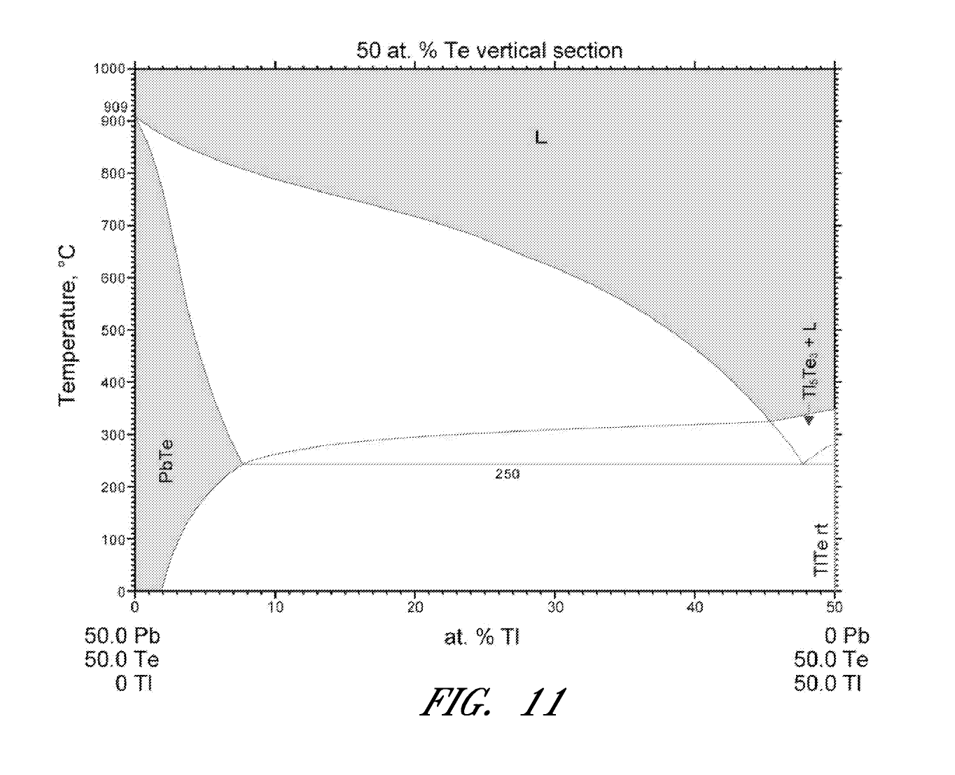

In contrast to the constant scattering exponent A, the method of four coefficients shows a factor of 3 increase in the effective mass (m*_{d}) over that of Na—PbTe (H. Preier, Appl. Phys. (Berl.), Vol. 20, pp. 189 (1979)), as shown in FIG. 9, calculated at E_{F}=50 meV for a classical nonparabolic band (Ravich et al). As seen in Eq. 2, such an increase in will m*_{d} will directly increase S by the same factor, as observed in these measurements. It is also consistent with the measurements of the electronic specific heat (Y. Matsushita et al., Phys. Rev. B, Vol. 74, pp. 134512 (2006)) as expected because both the specific heat and S are closely related to the entropy of the electrons (H. B. Callen, Thermodynamics (Wiley, New York, 1960)). The local increase in m*_{d} implies a decidedly nonparabolic perturbation in the electron dispersion relations and the density of states.

Because S and electronic heat capacity are sensitive to the change in the DOS at E_{F}, m*_{d} derived from these quantities is actually a measure of dn(E)/dE. The latter quantity will be enhanced for E_{F} close to the inflection point of the g(E) curve, as shown in FIG. 7A, which is closer to the valence band edge than the energy at which the DOS is maximum. Indeed, in certain embodiments, g(E) does not have a maximum in g(E). The measured value of E_{F} at 50 meV is consistent with this description, because the inflection point is expected to be near half the energy (˜30 meV in this case) at which a maximum in DOS is reported (S. A. Nemov et al., Physics-Uspekhi, Vol. 41, pp. 735 (1998)). In general, the sharper the local increase in DOS, the larger the enhancement in m*_{d} and in S. The agreement between the measurements of the enhancement in m*_{d}, specific heat, and our measured E_{F} for Tl—PbTe strongly supports this model as the source of enhanced S and ZT.

One feature observed in each of the measured Tl—PbTe samples is the local maximum in ρ near 200 K. It is attributed to a minimum in mobility that occurs at the same temperature at which the mass has a maximum. Thus, in certain embodiments, the maximum in ρ, or the minimum in μ, occurs at a temperature at which E_{F} nears an inflection point in the dispersion relation. Double-doping compounds to vary the Fermi energy can be used in accordance with certain embodiments described herein.

Further improvements in ZT are achievable in certain embodiments by systematically optimizing the location of E_{F} compared to the shape of g(E), for instance, by co-doping the samples with both Tl and another acceptor impurity such as Na. In addition to opening a new route to high-ZT materials that is not limited by the concept of minimum κ, certain such embodiments do not rely on the formation of nanoparticles, which are subject to grain growth or dissolution into the host material during operation. The method is independent of phonon properties, implying that improvements in ZT induced by reducing the lattice κ value can work in conjunction with the optimization of the location of E_{F}. Deliberately engineered impurity-induced band-structure distortions can be a generally applicable route to enhanced S and ZT in certain embodiments described herein. The origin of the band structure distortions is not limited to the presence of resonant levels of dopant. Other mechanisms can result in the distortion of electronic density of states, delivering enhanced thermoelectric properties as described above. One such mechanism can be the interaction between different bands of the thermoelectric material, where the presence and/or electron population in at least one additional electronic band or state distorts the DOS in the first band, thereby yielding enhanced Seebeck coefficient.

### Examples

### Pb₉₇Tl₂Na₁Te₉₂S₈

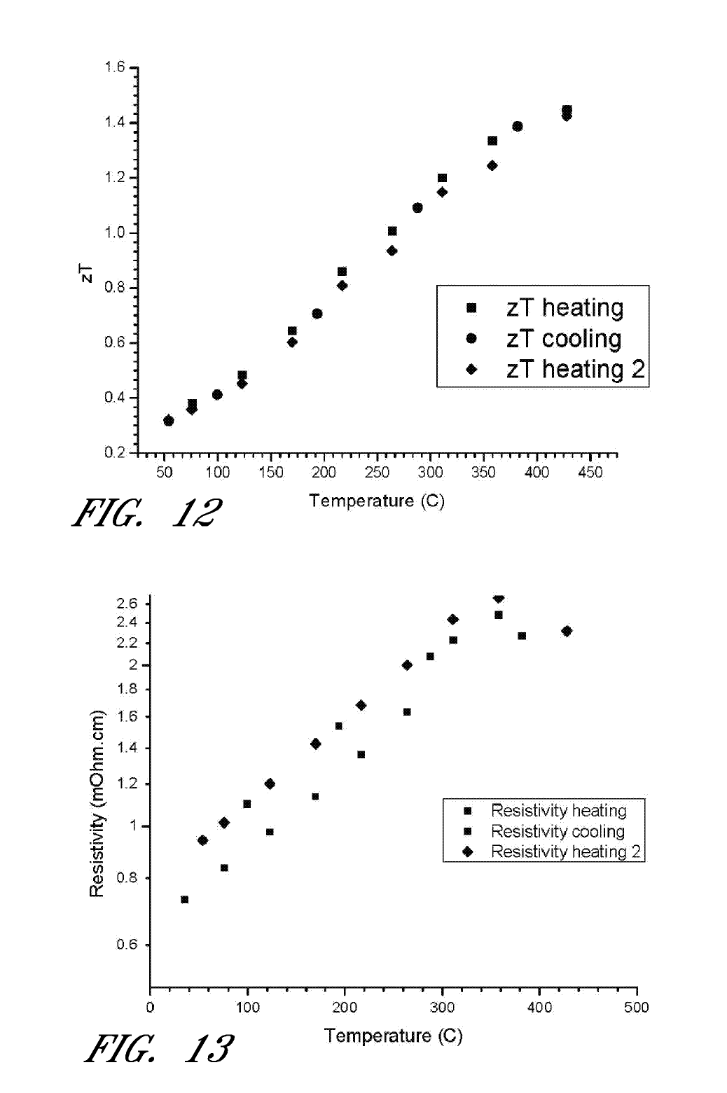

Sample materials were formulated and their properties measured. A sample of composition Pb₉₇Tl₂Na₁Te₉₂S₈ was produced, and the thermoelectric figure of merit ZT was measured on this sample, which is illustrated in FIG. 10.

The presence of sulfur at 8% increases the bandgap by 100 meV over that of the equivalent compound with no sulfur. The effect of sulfur on the valence band structure is not reported in the existing literature, and measurements discussed below indicate a distinct effect.

A similar method as Heremans et al. (Heremans et al., Science 321 p. 554 (2008), incorporated herein in its entirety by reference) was used to calculate effective mass, mobility, scattering parameter, and Fermi level of the Pb₉₇Tl₂Na₁Te₉₂S₈ sample. This method, however, is limited to about T<400 K, as noise in the experiments becomes too great to calculate these values with certainty. At T<400 K, the effective mass, scattering parameter, and Fermi level are about the same as in Pb_{0.98}Tl_{0.02}Te (see Heremans et al.). These results show that there is a distortion in the density of states that leads to the increase in Seebeck at 80 K<T<500 K.

A difference between the present Pb₉₇Tl₂Na₁Te₉₂S₈ sample, and samples without sulfur (see Heremans et al.) occurs in a temperature range of about 500 to 550 K. Transport data (e.g. measurements of the thermoelectric power, S (Seebeck coefficient), and of the electrical resistivity (ρ)) provide experimental evidence that the presence of the sulfur shifts the lower valence band (LVB) such that it is populated with holes at those higher temperatures. An increase in electrical resistivity and Seebeck coefficient indicate an effective mass increase. The increase in Seebeck coefficient outweighs the increase in resistivity so that the thermoelectric power factor P=S²ρ is increased. The power factor constitutes the numerator of the thermoelectric figure of merit ZT=PT/κ, where κ is the thermal conductivity. The increase in P results in the high ZT values shown in FIG. 10.

Frederick (Frederick et al., U.S. Pat. No. 3,527,622, incorporated herein in its entirety by reference) describes PbTe alloys. The measurements for the Pb₉₇Tl₂Na₁Te₉₂S₈ sample are in contrary to Fredrick, which states that the power factor P is decreased by the presence of sulfur in PbTe, and the reduction in thermal conductivity κ is what leads to an increase in zT. Additionally, Frederick uses an assumption of symmetric conduction and valence bands, which are contrary to the present measurements with the presence of sulfur. In further contradiction with Fredrick's contention that the power factor will be reduced due to the presence of sulfur in PbTe are the present electrical mobility measurements. The electrical mobility of a Pb₉₈Tl₂Te sample was 30×10⁻⁴ cm²/V-sec at 300K, and the electrical mobility of the Pb₉₇Tl₂Na₁Te₉₂S₈ was 60×10⁻⁴ cm²/V-sec at 300 K.

First, the presence of sodium in this Pb₉₇Tl₂Na₁Te₉₂S₈ sample provides a carrier concentration of 10²⁰ holes per cm³, which, without being bound by theory, may allow the holes to reach the LVB. Second, sulfur in PbTe:Tl materials (e.g., Pb₁₋ₓTlₓTe) may make manufacturing these materials easier than without sulfur. As illustrated in FIG. 11 (Rustamov P. G., Alidzhanov M. A., and Abilov C. I., PHYSICOCHEMICAL AND THERMOELECTRIC PROPERTIES OF ALLOYS OF THE SYSTEM PbTe—TlTe, Inorg. Mater., Vol. 10, 1974, p 1053-1056, incorporated herein in its entirety by reference), mixing the elements of Pb, Tl, and Te in a liquid state and then cooling through the liquidus may result in the formation of Tl₅Te₃. In certain embodiments, the formation of Tl₅Te₃ is undesired. Samples were produced in a similar fashion by cooling through the liquidus. Latent heat traces on a differential scanning calorimeter show endotherms at the temperatures of about 250° C. and about 280° C. as indicated in an appropriate Pb₁₋ₓTlₓS phase diagram to be a TlₐS_{b} second phase wherein a and b are nonzero. However, with the presence of small amounts of Na (e.g. less than 2%), this second phase is not formed upon cooling through the liquidus. This indicates that the Na shifts the two phase region.

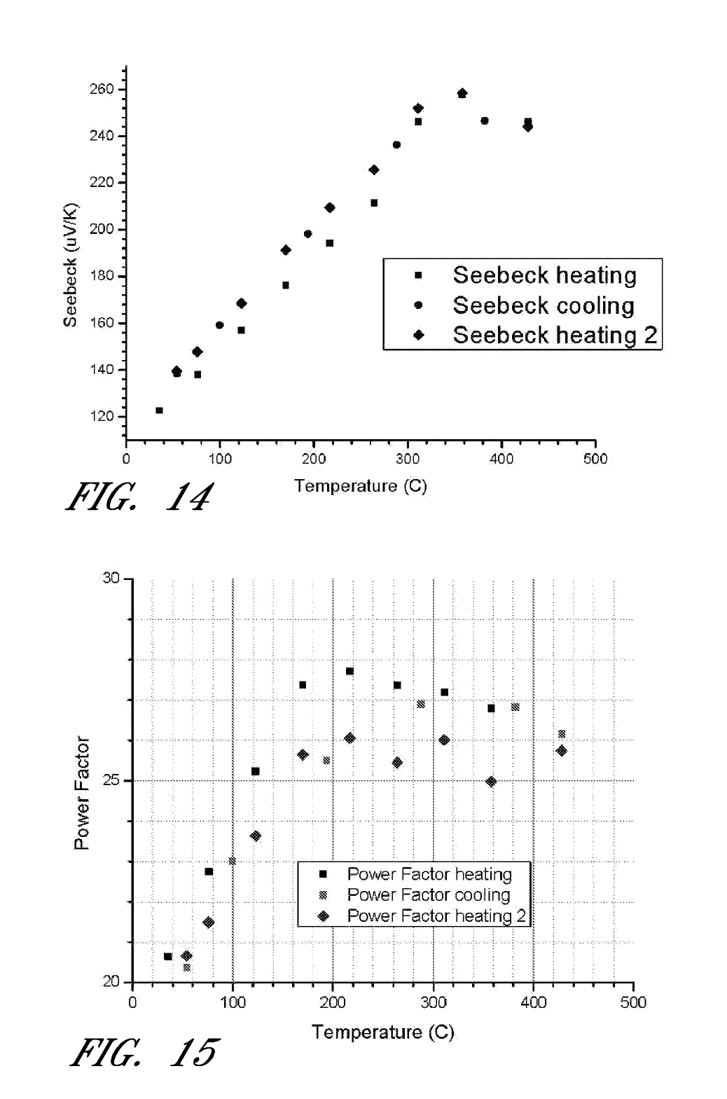

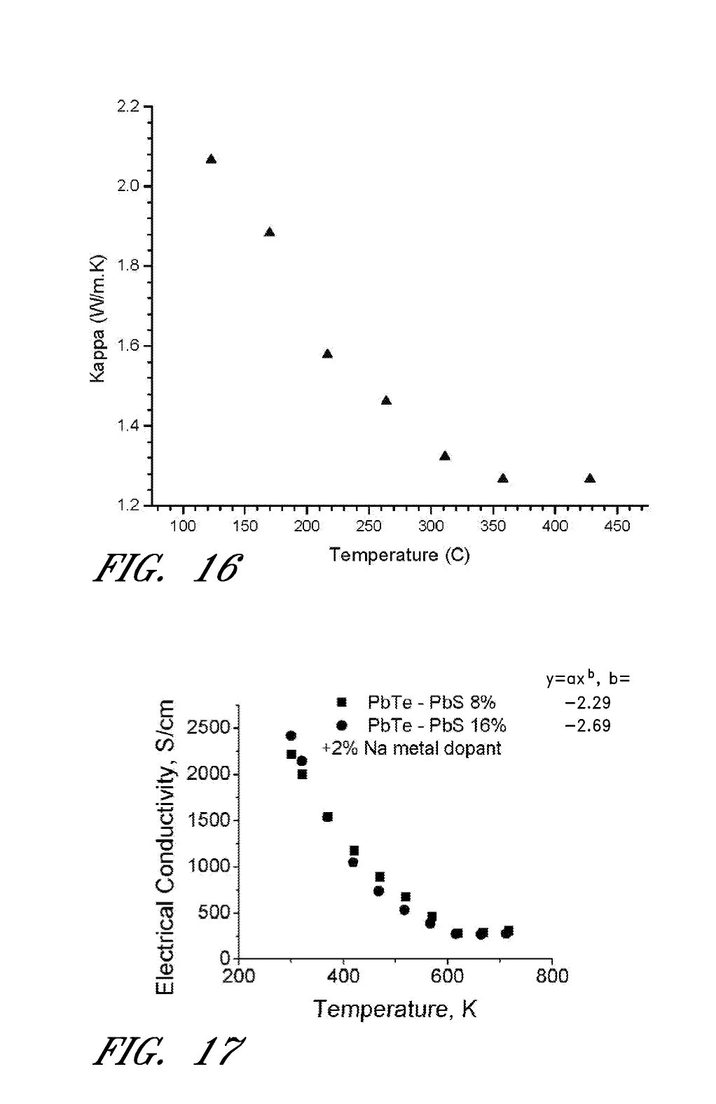

A second set of samples of composition Pb₉₇Tl₂Na₁Te₉₂S₈ was produced. A differential scanning calorimetry (DSC) trace showed no phase transitions in a temperature range of about room temperature to about 530° C. Electronic transport properties were measured in an ultra low vacuum (ULVAC) system. No damage or deformation was observed of the samples during this process. Unlike in some other PbTe:Tl systems, sample geometry remained unchanged. As illustrated in FIG. 12, the thermoelectric figure of merit ZT was measured to be about 1.42 to 1.46 at 430° C. Figure of merit was calculated using thermal diffusivity. Specific heat capacity was measured to be about 0.17 J/g-K, and density was measured to be about 8.16 g/cm³. FIGS. 13 and 14 illustrate measured resistivity and Seebeck, respectively. As illustrated in FIG. 15, the power factor showed some decay as material was cycled in the sequence of heating to 450° C., cooling to room temperature, and heating a second time to 450° C. FIG. 16 illustrates measured thermal conductivity, kappa (κ), as a function of temperature.

### Examples

### (PbTe₁₋ₓSₓ)_{0.98}(NaTe)_{0.02} (x=0.08 and 0.16)

Stock PbTe and PbS were synthesized using lead, tellurium, and sulfur with purities of at least 99.999%, 99.999%, and 99.99%, respectively. Lead, tellurium, and sulfur were loaded into quartz ampoules flame-sealed at a residual vacuum of about 10⁻⁴ Torr and reacted at least 50 K above the melting temperatures of the elements. The purity of the stock materials was verified using powder x-ray diffraction (PXRD) analysis. The composition (PbTe_{0.92}S_{0.08})_{0.98}(NaTe)_{0.02} was produced by adding about 7.55 g of PbTe and about 0.47 g of PbS to a new 8 mm inner diameter (I.D.) carbon-coated quartz ampoule with about 0.06 g (about 2 mol. %) tellurium. The ampoule was transferred to a glove box, and about 0.01 g (about 2 mol. %) sodium metal with purity of at least 99.95% was added to the ampoule. The final concentration after the above steps should be about [PbTe₁₋ₓSₓ]_{1-y}[NaTe]_{y}, wherein x equals 0.08 and y equals 0.02. Differing concentrations of PbS and NaTe dopant were also considered. The composition (PbTe_{0.84}S_{0.16})_{0.98}(NaTe)_{0.02} was produced by adding about 6.64 g PbTe, about 0.90 g PbS, about 0.6 g tellurium, and about 0.01 g sodium to an ampoule. The reaction was covered with parafilm, quickly transferred onto the Schlenk line, and flame-sealed at a residual vacuum of about 10⁻⁴ Torr. The sample was reacted at 1050° C. for approximately 8 hours in a box furnace, and then furnace-cooled with the furnace door open.

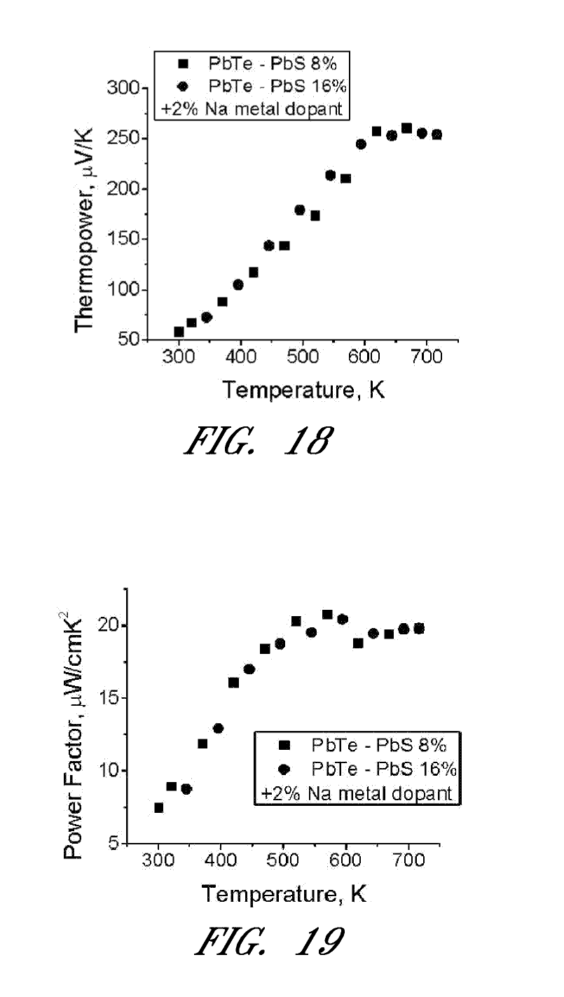

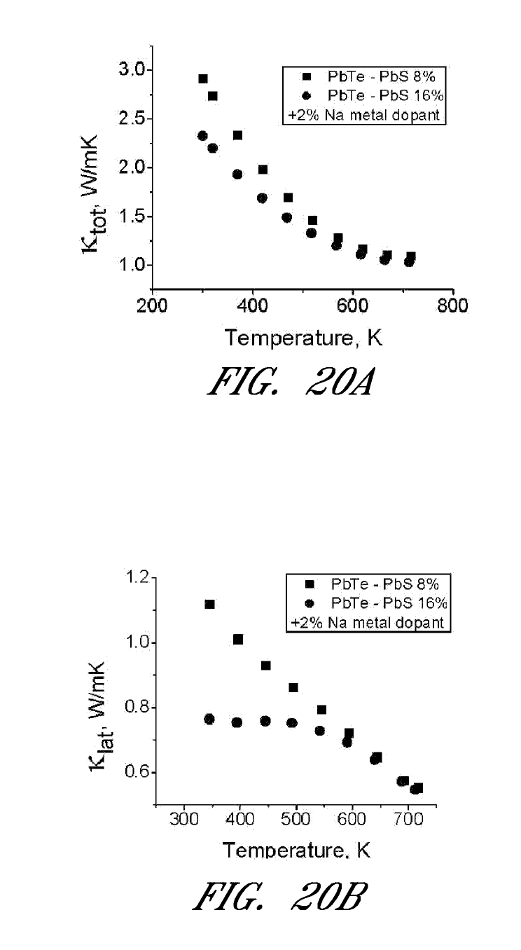

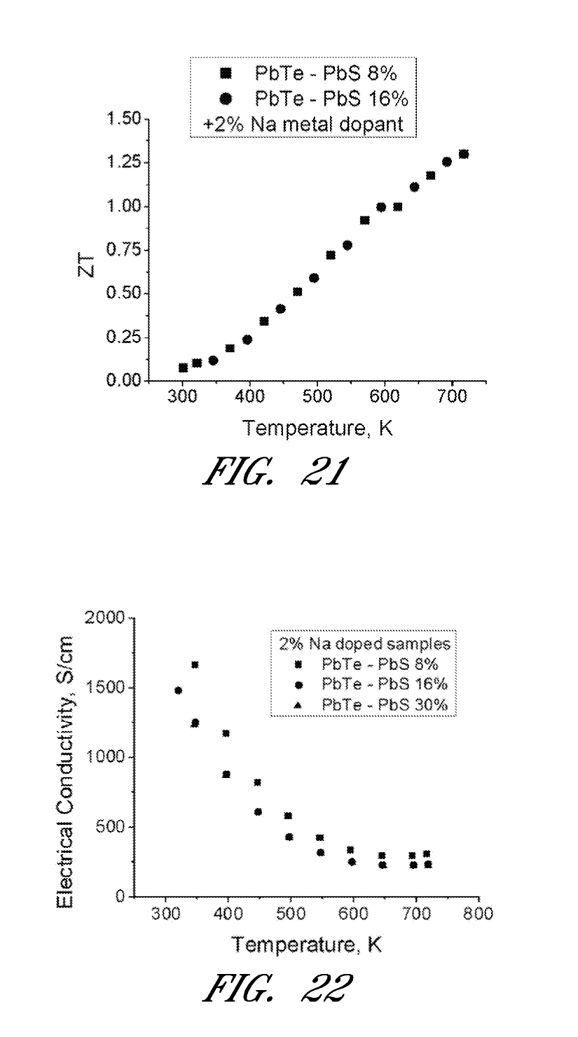

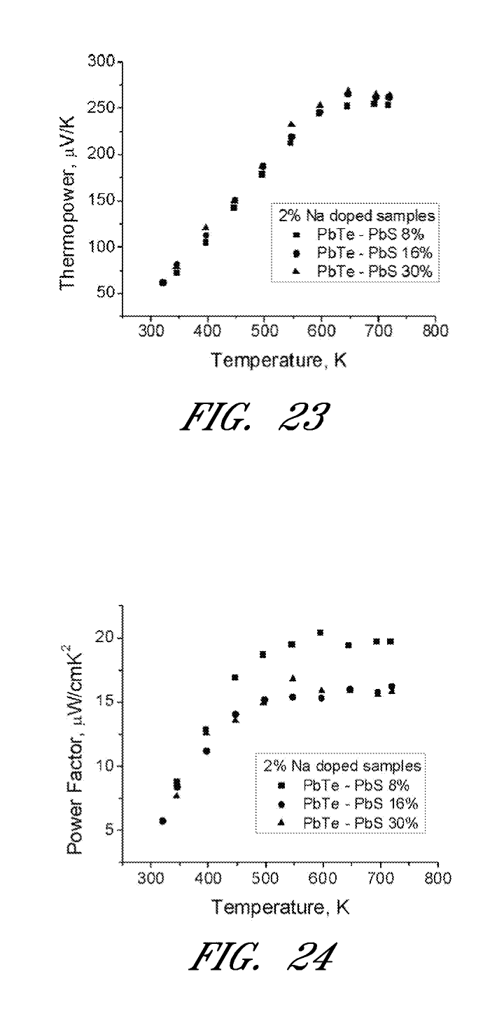

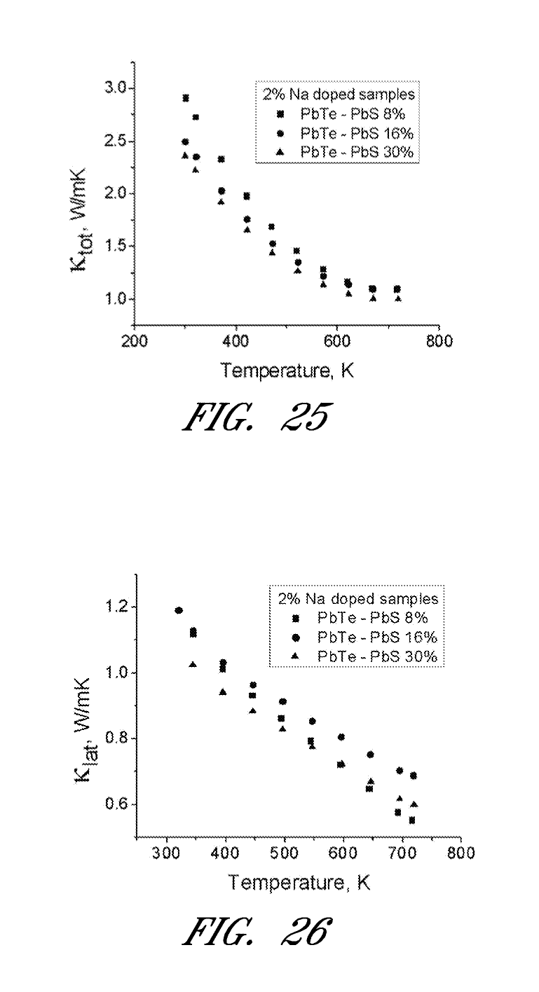

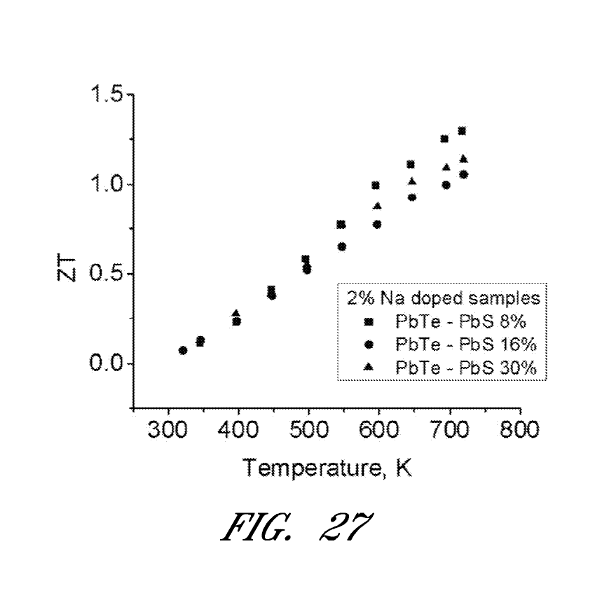

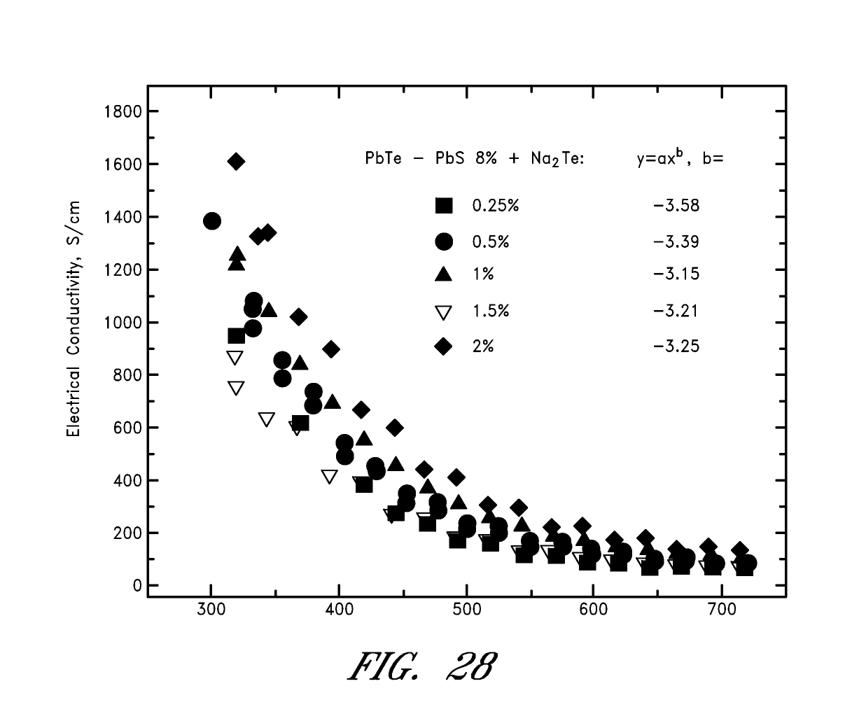

For the (PbTe_{0.92}S_{0.08})_{0.98}(NaTe)_{0.02} and (PbTe_{0.84}S_{0.16})_{0.98}(NaTe)_{0.02} samples, the electrical conductivity, Seebeck coefficient, power factor, total thermal conductivity, lattice thermal conductivity, and thermoelectric figure of merit measurements are show in FIGS. 17, 18, 19, 20A, 20B, and 21, respectively. As shown in FIG. 17, the electrical conductivity decreased as temperature increased until becoming constant at about 270 to 280 S/cm above about 600 K. Lattice thermal conductivity was about 0.55 W/mK at about 700 K and was significantly lower compared to p-type PbTe doped with sodium alone. As shown in FIG. 21, the ZT was about 1.3 to 1.5 at about 700 K.

### Examples

### (PbTe₁₋ₓSₓ)_{0.98}(NaTe)_{0.02} (x=0.08, 0.16, and 0.30)

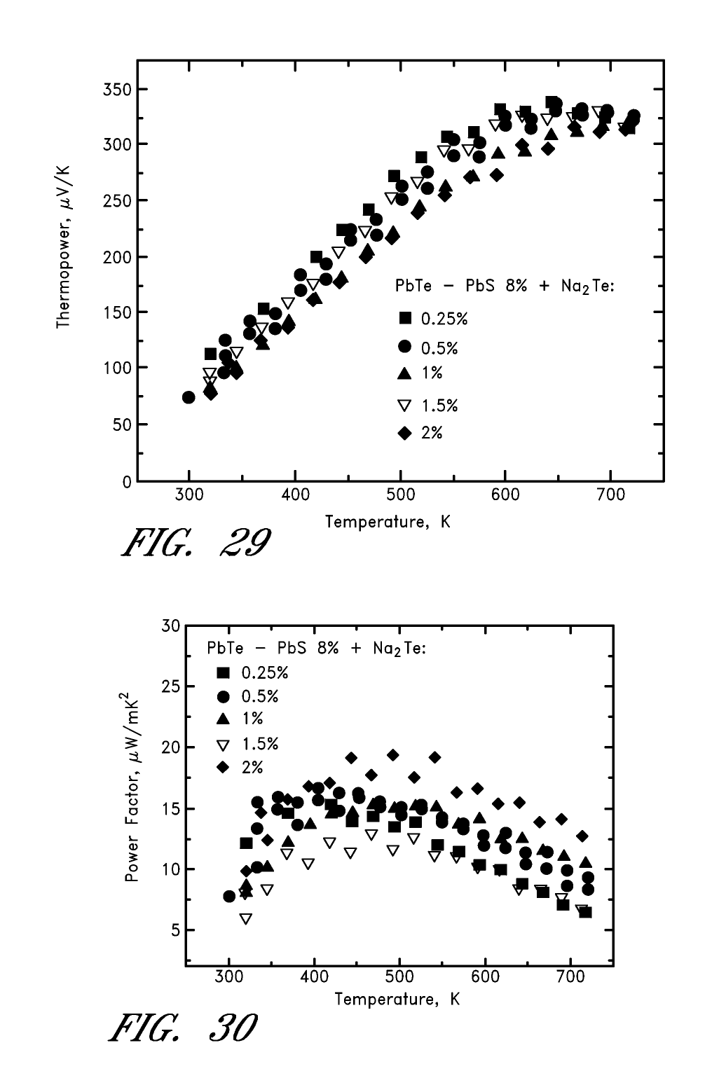

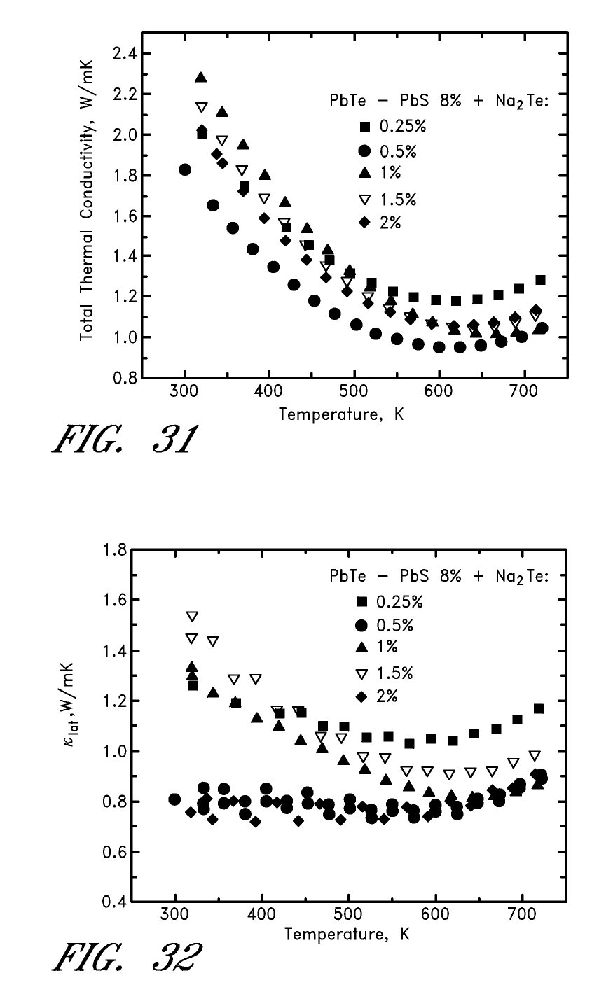

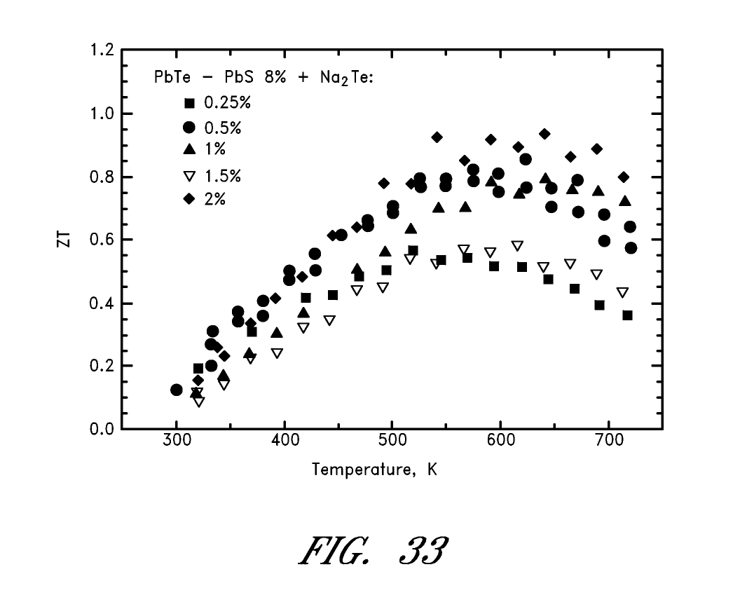

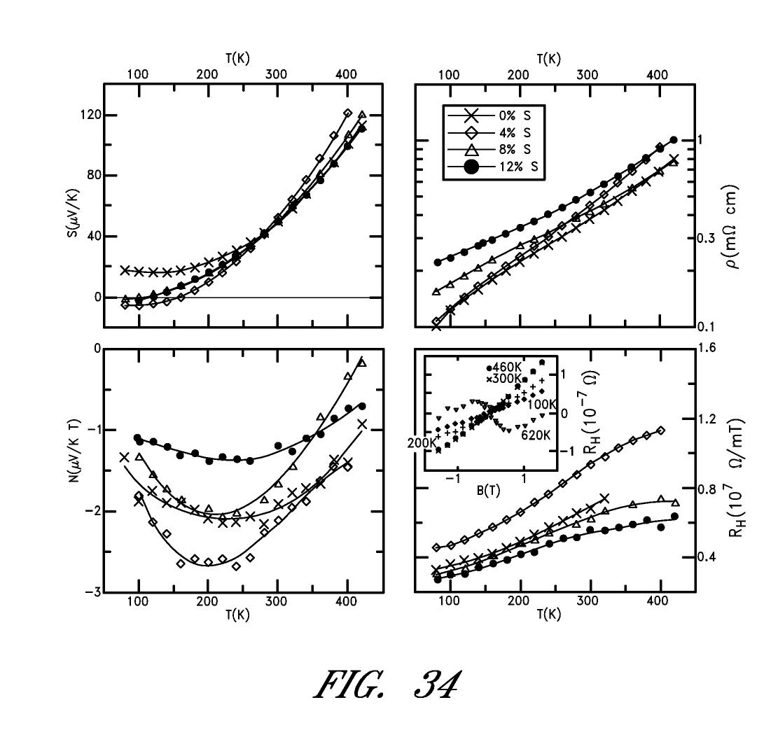

Sample materials of (PbTe₁₋ₓSₓ)_{0.98}(NaTe)_{0.02} wherein x equals 0.08, 0.16, and 0.30 were formulated and their properties measured similar to the previous example. For these samples, the electrical conductivity, Seebeck coefficient, power factor, total thermal conductivity, lattice thermal conductivity, and thermoelectric figure of merit measurements are shown in FIGS. 22, 23, 24, 25, 26, and 27, respectively. The addition of sodium may form some Na₂S, which may reduce the thermal conductivity.

### Examples

### (PbTe_{0.02}S_{0.08}) doped with Na₂Te

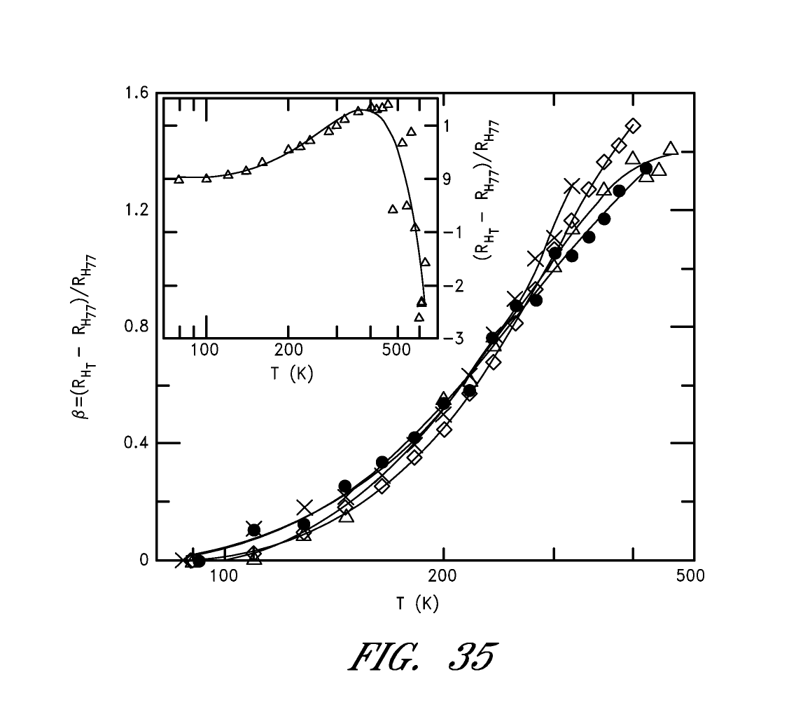

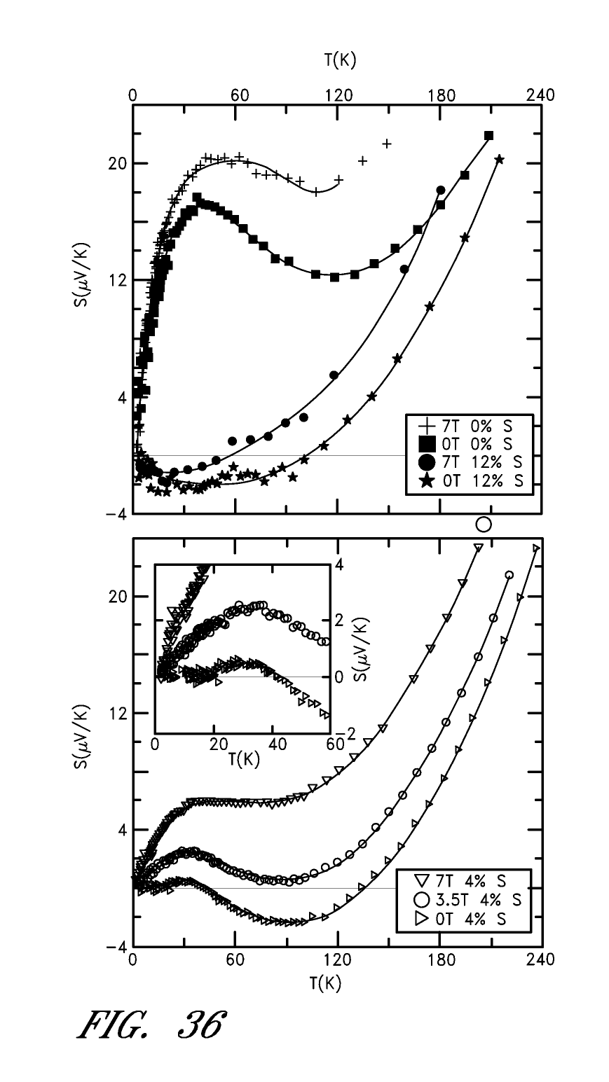

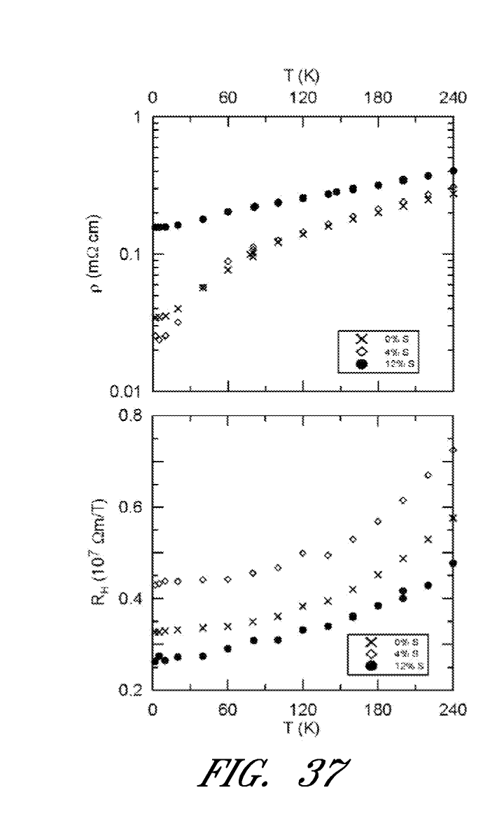

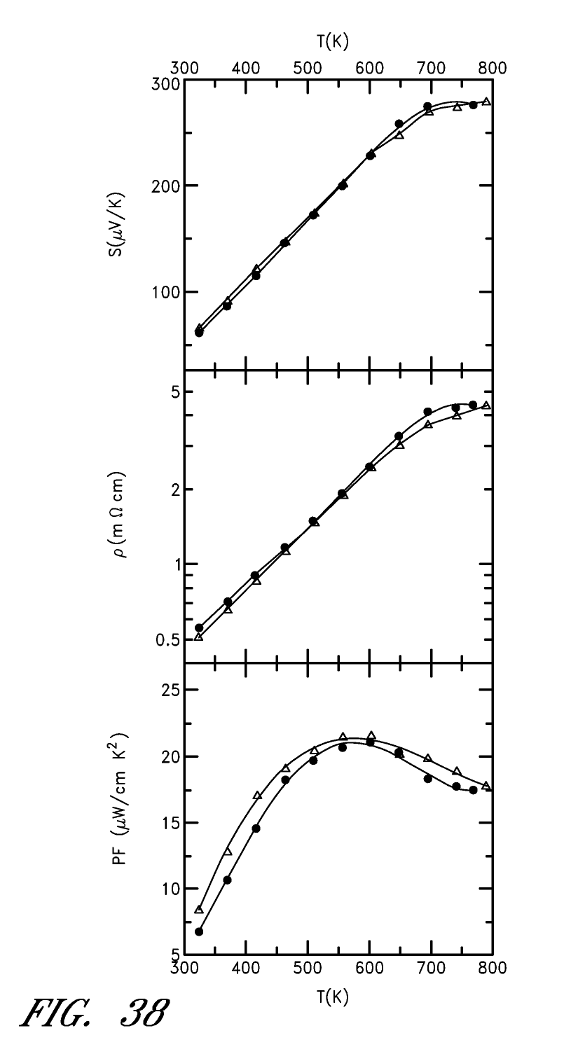

Sample materials of (PbTe_{0.92}S_{0.08})_{1-q}(Na₂Te)_{q} wherein q equals 0.08, 0.16, and 0.30 were formulated and their properties measured similar to the two previous examples. For these samples, the electrical conductivity, Seebeck coefficient, power factor, total thermal conductivity, lattice thermal conductivity, and thermoelectric figure of merit measurements are shown in FIGS. 28, 29, 30, 31, 32, and 33, respectively. As shown in FIG. 28, electrical conductivity has strong temperature dependence and decreases as temperature increases. As shown in FIG. 32, lattice thermal conductivity was higher than a n-type PbTe doped with sodium alone with 0.5 W/mK. These (PbTe_{0.92}S_{0.08})_{1-q}(Na₂Te)_{q} wherein q equals 0.08, 0.16, and 0.30 samples compared to the (PbTe_{0.92}S_{0.08})_{0.98}(NaTe)_{0.02} and (PbTe_{0.84}S_{0.16})_{0.98}(NaTe)_{0.02} samples had a lower carrier concentration, an electrical conductivity that fell at a faster rate as temperature increases, and a power factor about 20 μW/cmK² lower.

### Examples

### Pb_{0.99}Na_{0.01}Te₁₋ₓSₓ (x=0, 0.04, 0.08, and 0.12)

PbTe₁₋ₓSₓ alloys doped p-type by substitution of Na for Pb with x<0.16 were synthesized similar to the previous example. In particular, Pb_{0.99}Na_{0.01}Te₁₋ₓSₓ alloys with x=0, 0.04, 0.08, and 0.12 were produced. A molar concentration in PbTe corresponds to about 1.5×10²⁰ cm⁻³ atoms. Stoichiometric amounts of starting elements were loaded into carbon coated quartz ampoules, which were then sealed under high vacuum. After heating the ampoules to 1373 K, they were annealed at 1100 K, thus allowing for single phase material. Powder X-ray diffraction confirms the single phase nature and the lattice constant decreases with increasing sulfur content in accordance with Vegard's law.

Electrical resistivity ρ, Hall coefficient R_{H}, Nernst-Ettingshausen coefficient (Nernst or N), and Seebeck coefficient S were measured over 77 to 420 K in a conventional flow cryostat in stepped temperature and magnetic field (−1.4 T to 1.4 T) increments. Further, R_{H} and N are defined to be the low field slopes of their respective coefficients and standard corrections were applied to the Nernst coefficient. Measurements were extended to 2 K in a Quantum Design Physical Properties Measurement System (PPMS) in the AC Transport and Thermal Transport options (TTO). Error in S was increased due to the size of the thermometry of the TTO and unquantifiable uncertainties in the software analysis. High temperature thermal conductivity was measured using the equation κ=Cₚαρ_{d} where ρ_{d} is the mass density and is adjusted over temperature for the literature values of the thermal expansion coefficient of PbTe. Cₚ is the material specific heat. Cₚ was also measured in the Heat Capacity Option in the PPMS which is an absolute measurement and adjusted to match at 300 K. α is the thermal diffusivity and was measured using an Anter Corporation Flashline 3000. S and ρ were measured in the ultra low vacuum (ULVAC).

The galvanomagnetic and thermomagnetic properties from 80 to 420 K are shown in FIG. 34. S had unique temperature dependent phenomena. The sign changes from positive to negative in samples with sulfur as T is lowered. R_{H} indicates that this is a heavily doped p-type semiconductor, and as such, S should remain positive as T approaches 0 K. A similar switching in sign was observed in PbTe where Sb was substituted for Te. However, this resulted from a combination of a lower hole concentration (about 10¹⁹ cm⁻³) with highly mobile electrons. This was discerned from analysis of ρₓₓ and ρ_{xy} (magneto and Hall resistances) as functions of temperature and magnetic field. The thermopower is further discussed below. The large temperature dependence of R_{H} (T<450 K) is attributed to the redistribution of holes between the LVB and UVB. At 80 K, hole carrier density is high and >10²⁰ cm⁻³ for all samples. Electrical resistivity had unique trends. While at 200 K, ρ increases monotonically with x, which was not true at other temperatures. Compounds with x=0.08 and x=0.12 have similar temperature dependences, while compounds with x=0.04 and x=0.08 invert at 250 K with compounds with x=0.08 actually having lower ρ than compounds with x=0 at 400 K. Furthermore, compounds with x=0.04 had higher ρ than compounds with x=0.12 at higher T but lower ρ than compounds with x=0 at very low T. Without being bound by theory, these trends may have to do with the total number of carriers and their redistribution between the two bands such as Δ∈_{ν}=Δ∈_{ν}(x) as well as the modification of the dielectric constant. Nernst coefficient (N) is large for a heavily doped semiconductor and is negative. N for compounds with x>0 monotonically decreases in magnitude, while the magnitude of N for compounds with x=0.04 is larger than compounds with x=0, which may be attributed to the different scattering process in sulfur containing samples. This further indicates an enhanced scattering mechanism. Rogers, L. M., Brit. J. Appl. Phys. (J. Phys. D.) ser. 2 vol. 11067 (1968) also reported on N for a PbTe sample heavily doped with Na that has similar R_{H} values at 77 K as here; while the temperature dependence is similar, the magnitude is slightly off, with Rogers' N roughly double. It is unknown if Rogers is reporting the adiabatic or isothermal Nersnt coefficient, which may also explain this discrepancy. As expected, due to the LVB, all samples have very similar S at 300 K of 49-51 μV/K.

Seebeck was further investigated for the samples with x=0, 0.04, and 0.12 at lower temperature and in zero and high magnetic field, which are shown in FIG. 37. S of x=0 is positive at all temperature and has a phonon-drag peak, reaching 18 μV/K at 40 K in zero field before dropping to 12 μV/K at 120 K. S also exhibited magneto-Seebeck of approximately 40% at 120 K. S of x=0.12 changes sign at about 110 K in zero field and at about 60 K in 7 T. Compounds with x=0.04 switch negative at about 135 K, and with 3.5 T and 7 T external field S remains positive at all temperature. Furthermore, compounds with x=0.04 exhibit a phonon-drag effect in S, which is clearly seen at T<30 K. This increase is smaller than in x=0, as expected due to the reduced κ. In zero field, this phonon-drag actually switches sign of S again to positive at about 30 K (see inset of FIG. 36). As phonon-drag acts on the majority carrier, this is another indication that negative S is a result of a scattering effect due to the presence of sulfur and not from electrons.

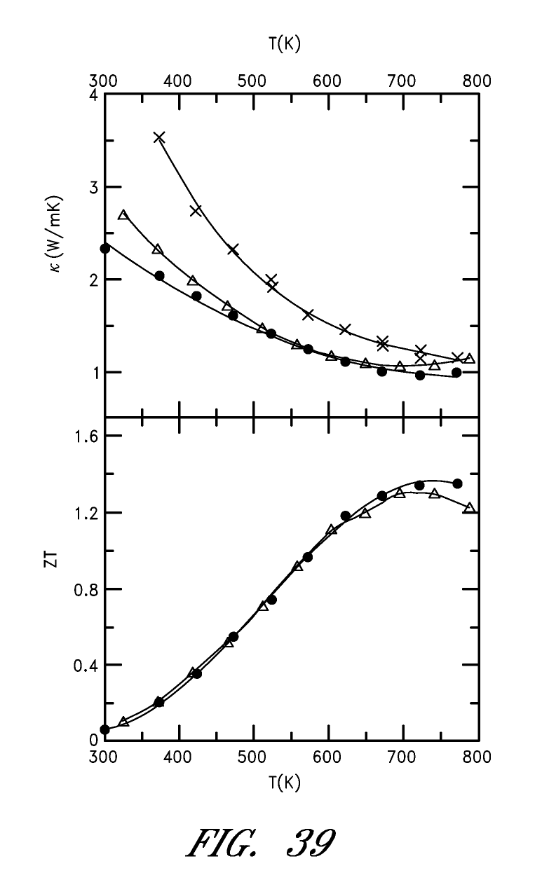

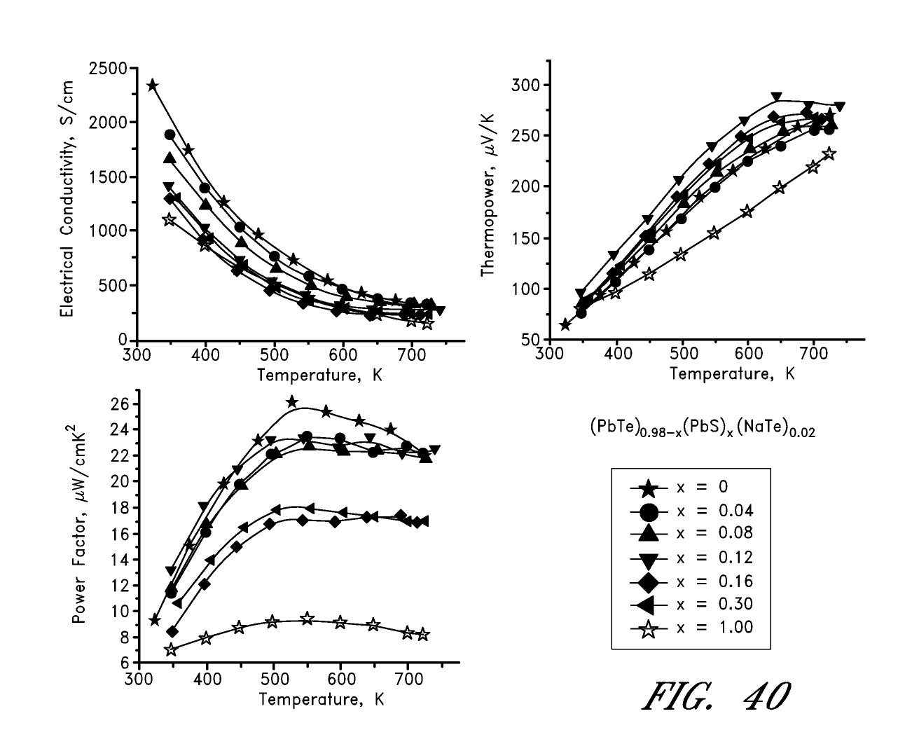

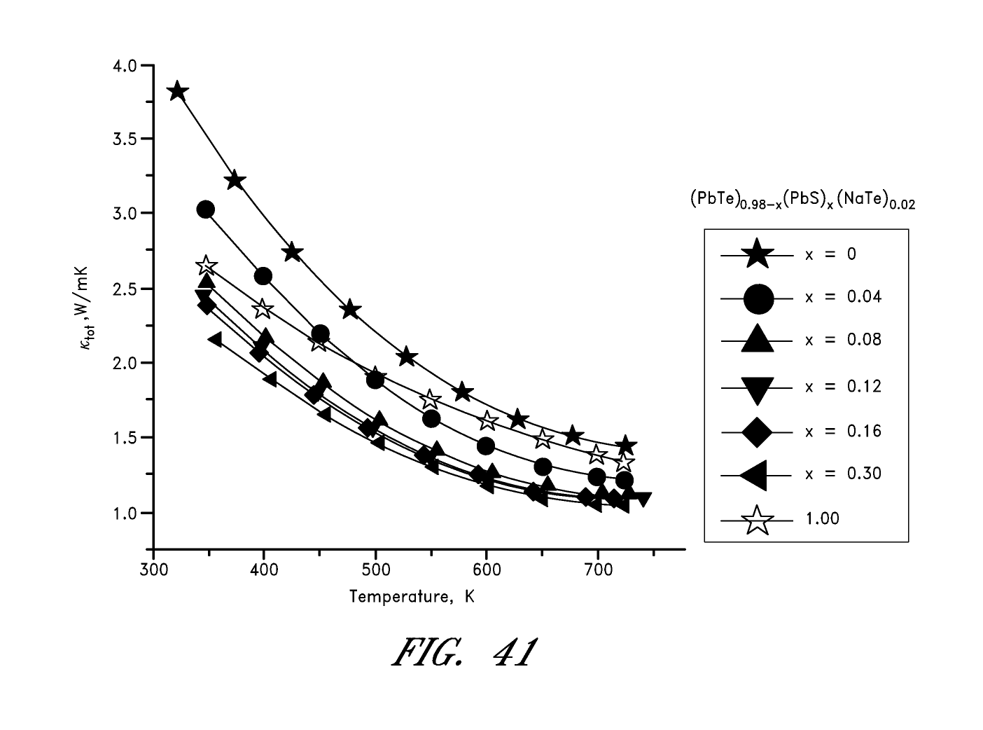

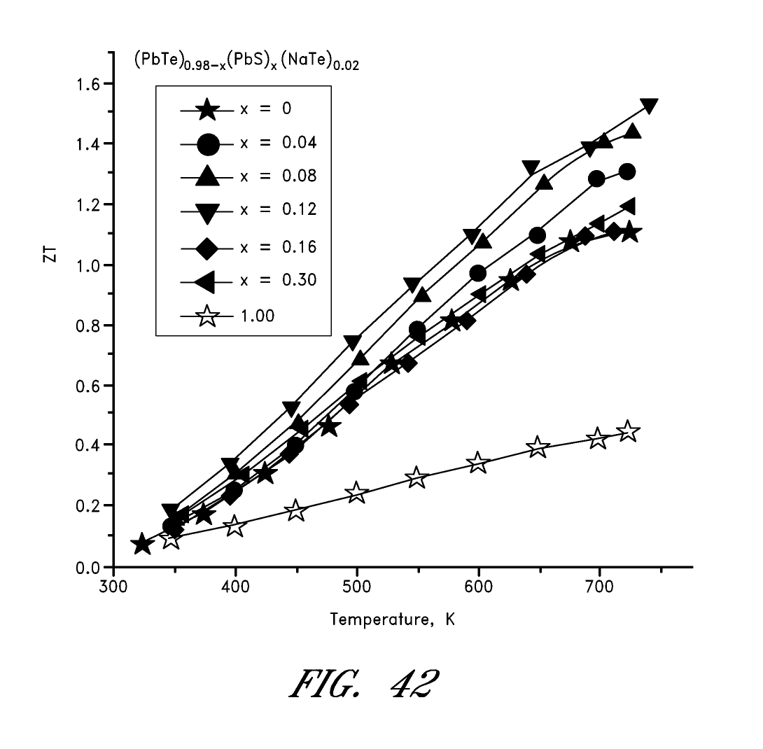

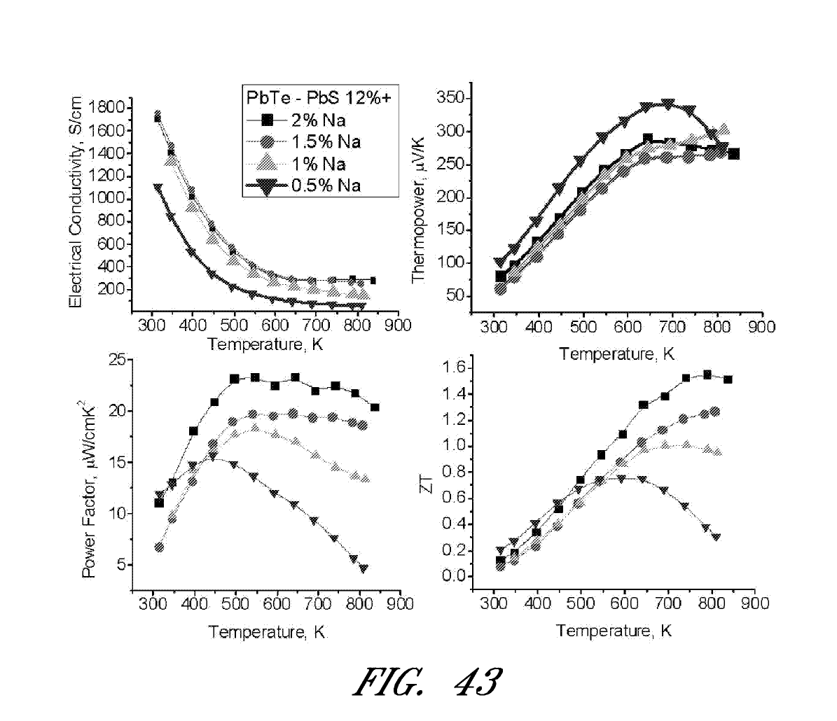

Illustrated in FIG. 37 is ρ and R_{H} for the three samples over the same range as the low temperature S measurement. The value of log(ρ(T)) changes slope for compounds with x=0 and x=0.04 at 60 K while for compounds with x=0.12 it remains constant. Furthermore, R_{H} remains positive and decreases with decreasing T. If a single carrier hole density is calculated from the formula p=A/R_{H}q at 2 K with A=1, more holes than Na atoms are added to the melt, as Crocker, A. J., J. Phys. Chem. Solids, 28, 10 1903-1912, (1967) reports when [Na]>6×10¹⁹ cm⁻³. Therefore, E_{F} for all samples is in the LVB at all temperatures. The shape of normalized hall coefficient is similar as Rogers reports for PbTe:Na with p of about 9×10¹⁹ cm⁻³ (see FIG. 35). There is no systematic trend in the magnitude of R_{H}; this most likely arises from unavoidable small variations in sample preparation due to the high reactivity of sodium and annealing at 1100 K to achieve a single phase material. Crocker also experienced similar issues when annealing at 1073 K. Furthermore, PbS and PbTe have different Δ∈ᵥ and ∈_{g}, which will affect the Hall prefactor. A two band analysis from 77 to 620 K using ρₓₓ(B_{z}) and ρ_{xy}(B_{z}) (magnetoresistance and Hall resistance) was preformed. The UVB band was assumed to have at least five times higher electrical mobility than the LVB, as inferred from the effective mass of each band. While not shown, this analysis on compounds with x=0.08 confirms earlier reports of a temperature dependent distribution of carriers between the UVB and LVB; with pₜₒₜₐₗ>8×10¹⁹ cm⁻³ and P_{UVB}>p_{LVB} at low T, which is inverted at T>400K. Between 500 K and 600 K, the sign of R_{H} inverts. At T≧600 K, low field R_{H} is negative, from high mobility thermally activated electrons while high field R_{H} is positive from the dominant heavy holes. Selected temperatures of R_{H} on compounds with x=0.08 are shown in the inset of FIG. 34. The temperature dependence has a low field slope that increases from 100 K to 460 K, and then turns negative. The effects of this carrier are also witnessed in higher temperature S, which remains approximately constant at higher temperature (see FIG. 39).

While the two carrier system diminishes the accuracy of the Method of the 4 Coefficients, it still yields qualitative results. The fits indicate that the scattering parameter increases monotonically with T, is large and negative at 80 K, and becomes positive at a temperature of about 300 K. Without being bound by theory, this theoretically confirms the magnetic field measurements and explains the T² relation of S: one T¹ is a result of the T in Mott relation and the second T¹ stems from λ in the Mott relation. This unique temperature dependence on samples with sulfur is likely related to interband scattering, with the increased ∈_{g} and respective location of the LVB and Na energy level fall just right.

The measurements on compounds with x=0.08 and x=0.12 were extended to higher temperatures and show S, ρ, and power factor in FIG. 38. The two samples have similar Seebeck coefficients, which are linear with respect to temperature, peak at about 280 μV/K at 650 K and then remain flat. Without being bound by theory, this is likely attributed to the appearance of thermally excited electrons, which is also witnessed in ρ and directly reflected in Hall coefficient (inset of FIG. 34). ρ remains low and peaks at about 4.5 mΩ-cm for compounds with x=0.12. Power factor shows a peak at 21 μW/cm K² in compounds with x=0.12.

Thermal conductivity shows a monotonic decrease with increasing sulfur content, as expected and is shown in FIG. 39. This decrease stems from the reduction in lattice thermal conductivity, as the samples have similar ρ. zT reaches a high value of about 1.3 above 700 K and remains above 1 at T>575 K. This may be due to a high scattering parameter, which suggests that efficient thermoelectric materials can be developed using this technique to increase Seebeck coefficient.

As discussed above, p-type PbTeS alloys exhibit unique thermoelectric properties, most notably the temperature dependence of thermopower due to scattering mechanisms. Although heavily p-type (carrier density>10¹⁹ cm⁻³), the Seebeck coefficient (S) switches from positive to negative at low temperature (about 150 K) in samples with x≧0.04. The Seebeck coefficient is proportional to T² over a wide temperature regime, departing from the normal T¹ for a degenerately doped semiconductor. Without being bound by theory, this is related to temperature dependent hole scattering by measuring Seebeck in high magnetic field, which lowers or eliminates the switching temperature (S(T)=0). Further, these materials exhibit good power factors (>20 μW/cm K²) at elevated temperatures, and with low lattice thermal conductivity. For example, Pb₉₉Na₁Te₉₂S₈ had a zT of about 1.3 at 773 K. Furthermore, similar material efficiencies have been reached without the usage of Tl in PbTe alloys and have reduced the amount of Te to make an efficient thermoelectric module.

### Examples

### (PbTe₁₋ₓSₓ)_{0.98}(NaTe)_{0.02} (x=0.04, 0.08, 0.12, 0.16, 0.30, and 1.00)

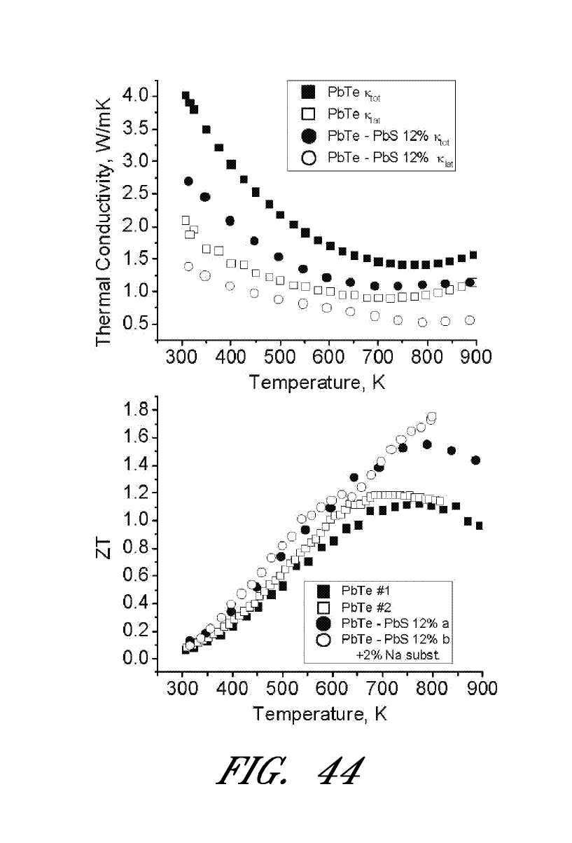

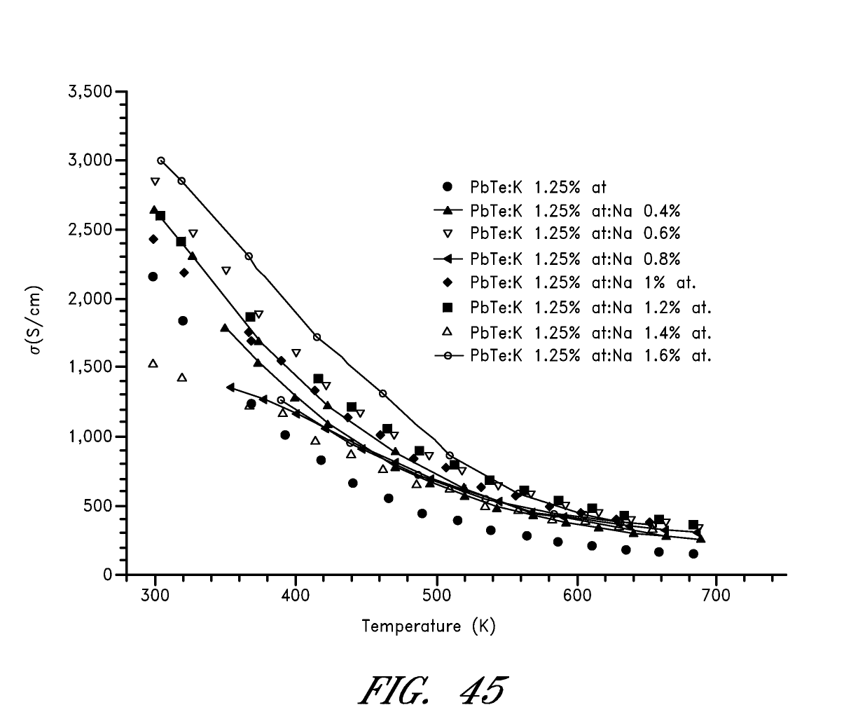

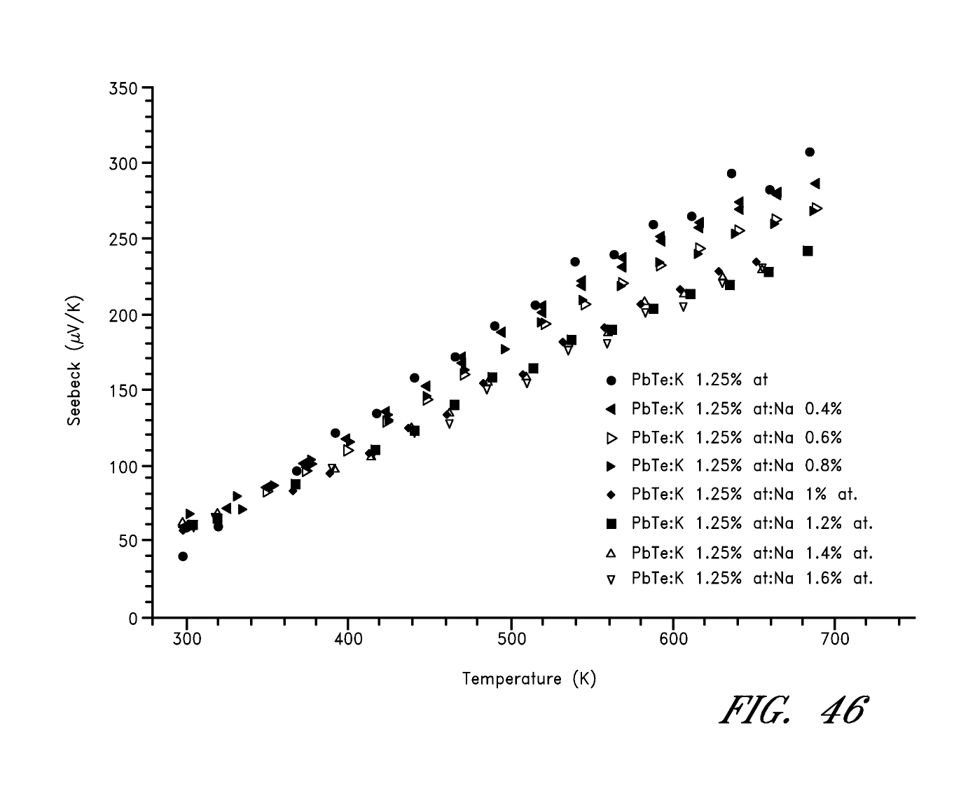

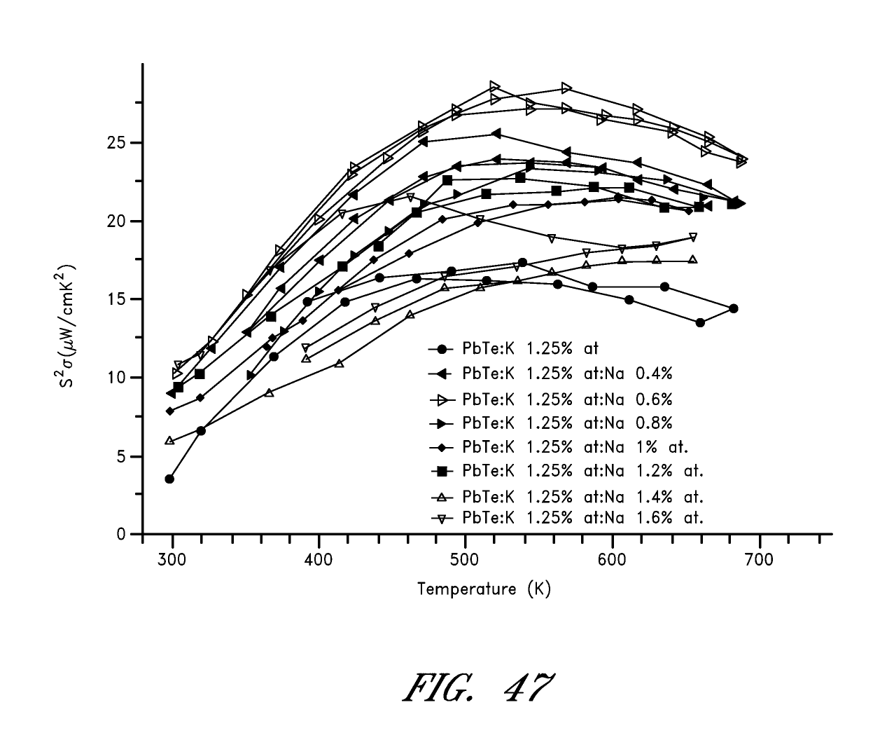

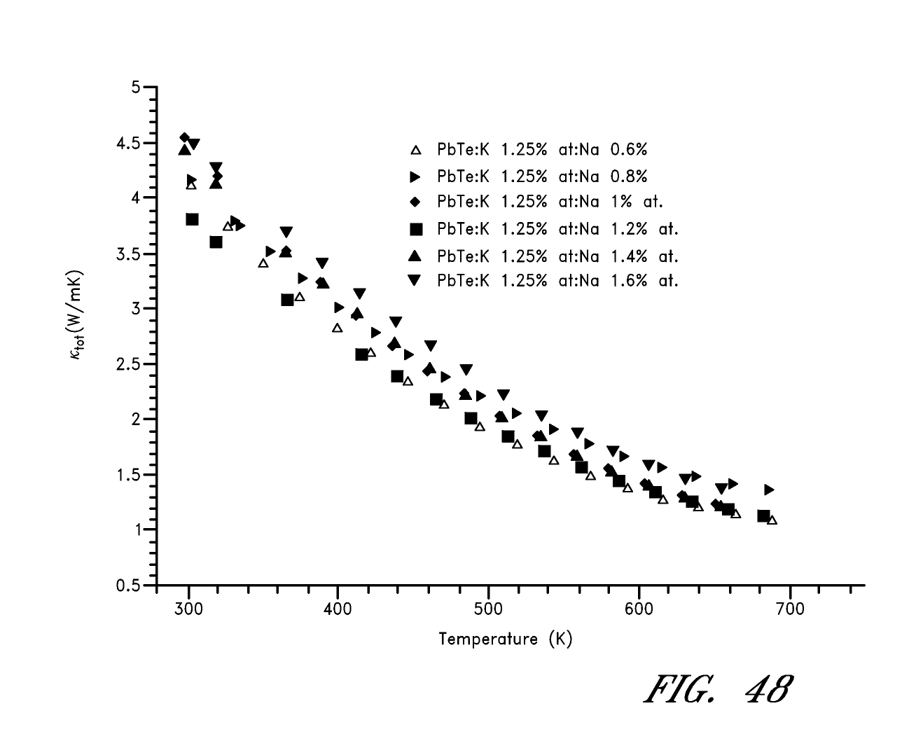

Sample materials of (PbTe₁₋ₓSₓ)_{0.98}(NaTe)_{0.02} wherein x equals 0.04, 0.08, 0.16, 0.30 and 1.00 were formulated and their properties measured similar to the previous example. For these samples, the electrical conductivity, Seebeck coefficient, power factor, total thermal conductivity, lattice thermal conductivity, thermoelectric figure of merit measurements, and comparison of thermoelectric figure of merit with conventional PbTe material are shown in FIGS. 40, 41, and 42. The addition of sodium may form some Na₂S, which may reduce the thermal conductivity. FIG. 43 illustrates (PbTe)_{0.88}(PbS)_{0.12} compositions with various sodium (Na) doping concentrations. FIG. 44 illustrates comparative examples of PbTe without sodium doping and (PbTe)_{0.88}(PbS)_{0.12} with sodium doping.

### Examples

### Pb_{0.9875-z}K_{0.0125}Na_{z}Te (z=0.004, 0.006, 0.008, 0.01, 0.012, 0.014, and 0.016)

Samples with the chemical formula Pb_{0.9875-z}K_{0.0125}Na_{z}Te were produced at high temperature via direct reaction of high purity elemental lead, tellurium, potassium, and sodium in carbon coated, 8 mm inside diameter, 1 mm wall thick, silica tubes. The elemental lead, tellurium, potassium, and sodium had purities of at least 99.999%, 99.999%, 99.9%, and 99.9%, respectively. All silica tubes were loaded inside a glove box under nitrogen gas atmosphere, with about 15 mg of potassium and about 4.5 mg to 12 mg of sodium depending on z. A clean, heat dried razor blade was used to remove oxidation from the surface of large potassium lumps and used to cut appropriate smaller pieces. A similar procedure was repeated on sodium with a different razor blade. The appropriate quantities of lead (about 6.5 g of lead per 10 g of the sample) and tellurium (about 3.835 g of tellurium per 10 g of the sample) were placed in sterilized glass vials outside of the glove-box and added in the corresponding tube inside the glove box. The tubes were then covered with parafilm polymeric membrane which was removed moments before evacuating (10⁻⁴ Torr) and sealing. The sealed tubes were placed inside a Lindberg box type furnace, fired at 1050° C. for at least 12 hours, and then quickly cooled to room temperature.

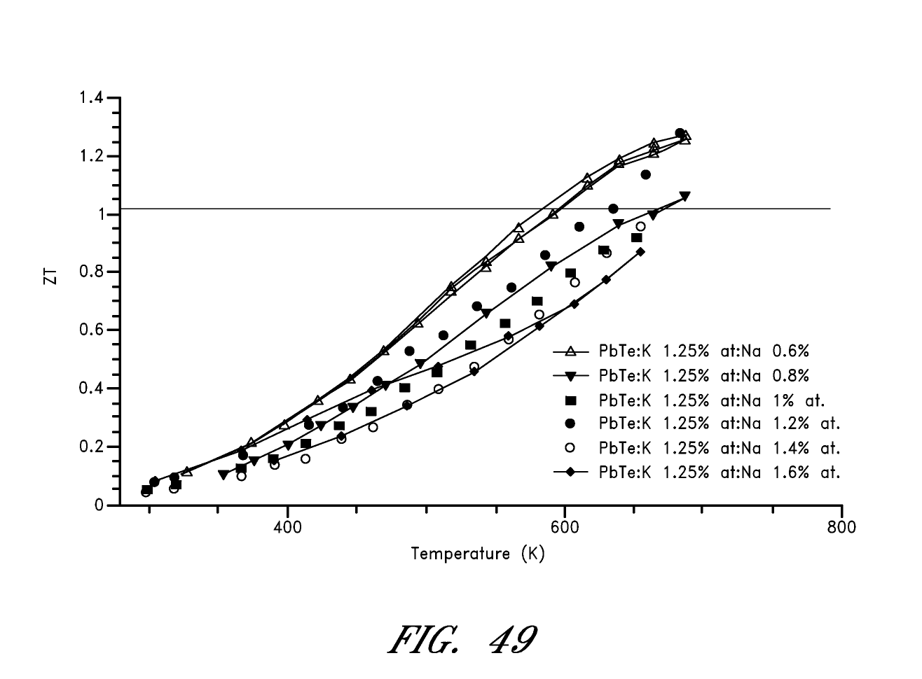

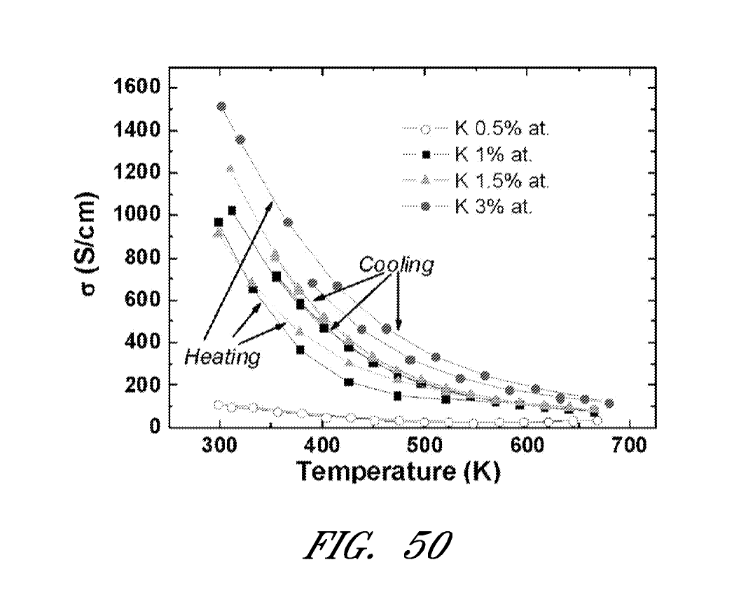

A series of samples with the co-doped compositions of Pb_{0.9875-z}K_{0.0125}Na_{z}Te wherein z equals 0.004, 0.006, 0.008, 0.01, 0.012, 0.014, and 0.016 were prepared and characterized. Electrical conductivity measurements as a function of temperature are shown in FIG. 45. The electrical conductivity was consistently high with the best samples showing room temperature values of over 2,000 S/cm. The Seebeck coefficients of these samples are shown in FIG. 46. The power factors for these samples are shown in FIG. 47. Typical power factors were greater than 20 μW/cm-K². The corresponding data for total thermal conductivity and thermoelectric figure of merit (ZT) values are shown in FIG. 48 and FIG. 49, respectively.

### Examples

### (PbTe_{0.92}S_{0.08}) doped with K

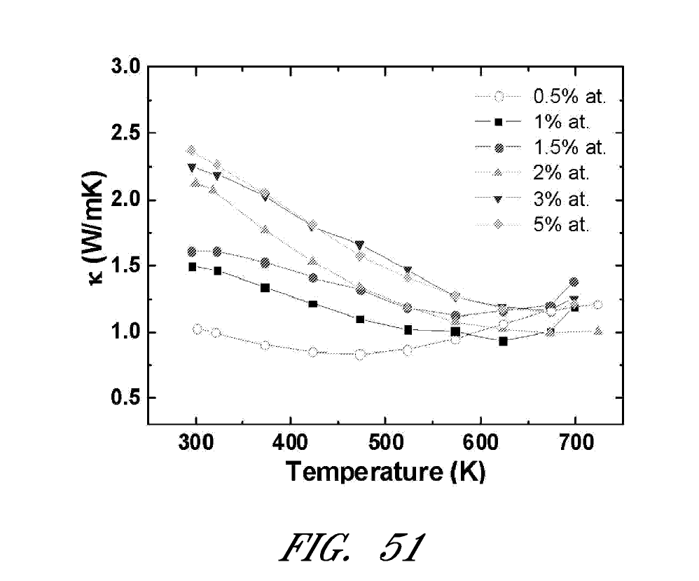

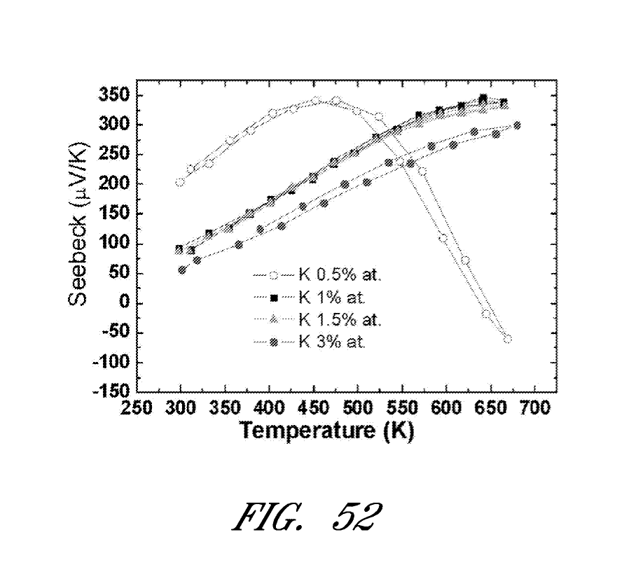

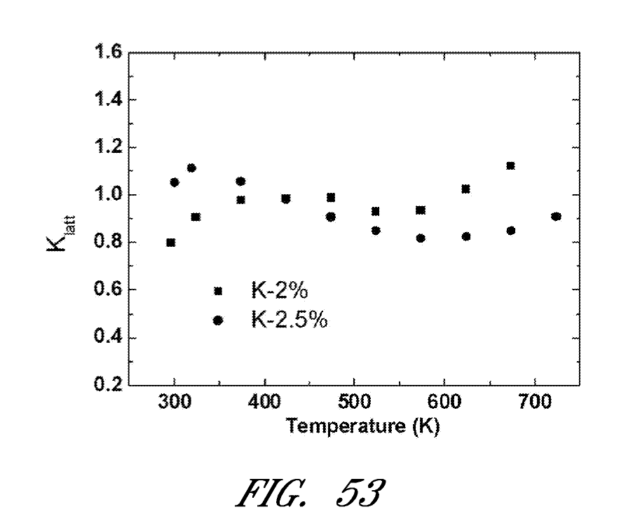

Sample materials of Pb₁₋ᵤKᵤTe_{0.92}S_{0.08} wherein u equaled 0.005, 0.01, 0.015, and 0.03 were formulated and their properties measured similar to the previous example. For these samples, the electrical conductivity, total thermal conductivity, Seebeck coefficient, and lattice thermal conductivity measurements are shown in FIGS. 50, 51, 52, and 53, respectively. As shown in FIG. 50, the sampled doped with potassium show strong scattering and irreversibility was observed. The electrical conductivity has a dependence on temperature with a general dependence of σ˜T^{m}, wherein 3<m<4.3. The irreversibility of thermal conductivity was strongest where u was between about 0.01 and 0.025 (e.g., the irreversibility of the thermal conductivity was lower where u was not between about 0.01 and 0.025). The electronic thermal conductivities were calculated for the samples exhibiting the smallest thermal hysteretic behavior wherein an average σ and a Lorenz number of 2.45×10⁻⁸ W ohm/K² was used.

### Examples

### Pb₁₋ᵤTeKᵤ (u=0.0125) and Pb_{1-z-u}TeNa_{z}Kᵤ (z=0.006 and u=0.0125)

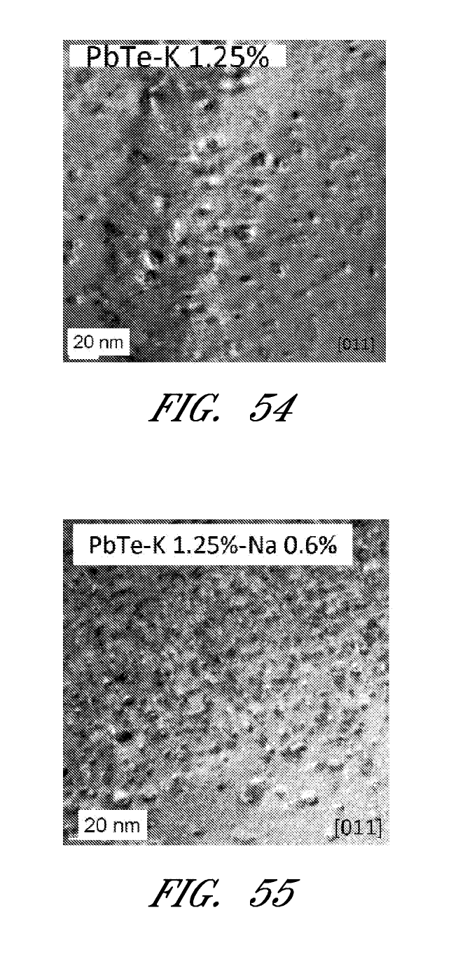

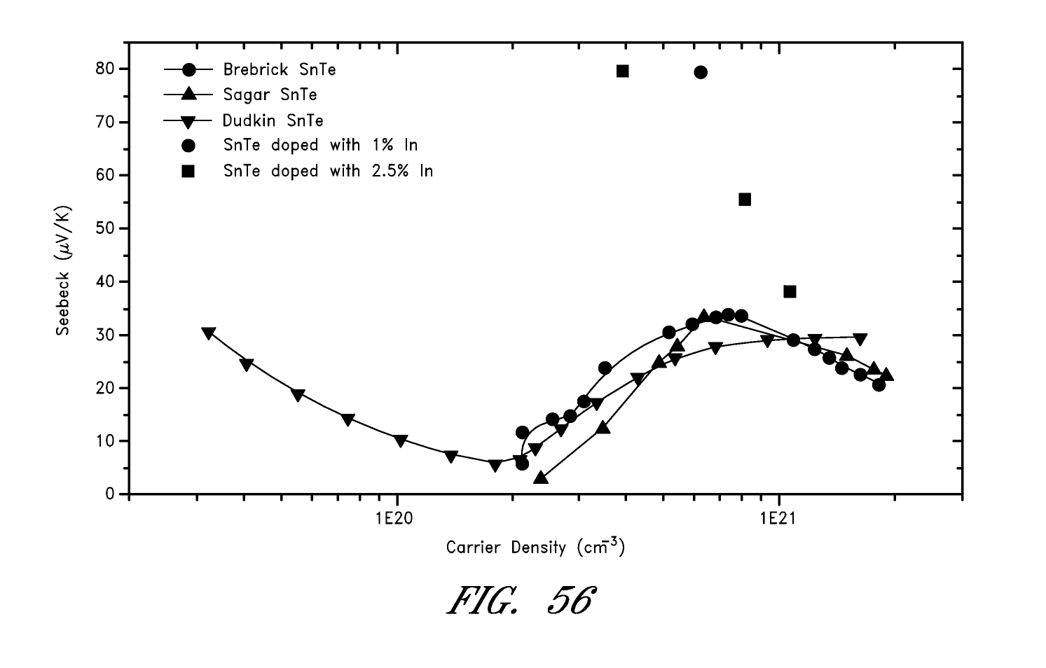

Samples of Pb₁₋ᵤTeKᵤ wherein u=0.0125 and Pb_{1-z-u}TeNa_{z}Kᵤ wherein z=0.006 and u=0.0125 were produced similar to the previous example. FIG. 54 is a transmission electron microscope (TEM) image showing nanoscale inhomogeneties or nanoprecipitates in the Pb_{0.9875}TeK_{0.0125} sample. FIG. 55 is a TEM image showing nanoscale inhomogeneites or nanoprecipitates in the Pb_{0.9815}TeNa_{0.006}K_{0.0125} sample.

### Examples

### SnTe doped with 1 atomic % In and SnTe doped with 2.5 atomic % In

Samples of SnTe doped with either 1 atomic % or 2.5 atomic % indium were produced similar to the previous example. FIG. 56 is a plot of Seebeck coefficient as a function of carrier density for these samples at a temperature of 300 K. Also plotted in FIG. 56 is data for SnTe without indium doping as reported by Brebrick R. F. et. al. 1963 Phys. Rev. 131 104, Sagar A et. al 1962 International Conference on the Physics of Semiconductors 653, and Dudkin L. D. et. al. 1972 Soviet Physics Semiconductors Vol. 6, 1934. Seebeck is higher for the indium doped samples in certain carrier concentrations.

Various embodiments have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A thermoelectric material comprising at least one compound having a general composition of A_{w-t}Te₁₋ᵣEᵣDₜ, wherein w>t, 0<r≦0.30, 0<t≦0.05, wherein A is selected from the group consisting of lead and tin, Te is tellurium, D is selected from the group consisting of sodium, potassium, thallium, and E is selected from the group consisting of sulfur and selenium.

2. The thermoelectric material of claim 1, wherein 0.08≦r≦0.12.

3. The thermoelectric material of claim 1, wherein 0.01≦t≦0.03.

4. The thermoelectric material of claim 1, wherein 0.94≦w≦1.06.

5. The thermoelectric material of claim 1, wherein the at least one compound is p-type.

6. The thermoelectric material of claim 1, wherein D comprises thallium.

7. The thermoelectric material of claim 6, wherein E comprises sulfur.

8. The thermoelectric material of claim 1, wherein D comprises sodium.

9. The thermoelectric material of claim 8, wherein E comprises sulfur.

10. The thermoelectric material of claim 1, wherein D comprises potassium.

11. The thermoelectric material of claim 10, wherein E comprises sulfur.

12. The thermoelectric material of claim 1, wherein A comprises tin.

13. The thermoelectric material of claim 12, wherein D comprises indium.

14. The thermoelectric material of claim 13, wherein E comprises selenium.

15. A thermoelectric material comprising at least one compound having a general composition of A_{w-t}Te₁Dₜ, wherein w>t, 0<t≦0.05, wherein A is selected from the group consisting of lead and tin, Te is tellurium, and D consists of sodium and potassium.

16. The thermoelectric material of claim 15, wherein 0.01≦t≦0.03.

17. The thermoelectric material of claim 15, wherein at least 10 atomic % of D is sodium and at least 10 atomic % of D is potassium.

18. The thermoelectric material of claim 15, wherein 0.94≦w≦1.06.

19. The thermoelectric material of claim 15, wherein the at least one compound is p-type.

20. The thermoelectric material of claim 15, wherein the at least one compound further comprises thallium.

21. A method of using a thermoelectric material comprising:
providing a thermoelectric material comprising at least one compound having a general composition of A_{w-t}Te₁Dₜ, wherein w>t, 0<t≦0.05, wherein A is selected from the group consisting of lead and tin, Te is tellurium, and D consists of sodium and thallium; and
exposing at least one portion of the at least one compound to a temperature greater than about 550 K during use of the thermoelectric material.

22. The method of claim 21, wherein 0.01≦t≦0.03.

23. The method of claim 21, wherein the at least one compound further comprises potassium.

24. The method of claim 21, wherein the at least one portion of the at least one compound is exposed to a temperature greater than about 700 K during use of the thermoelectric material.

25. The method of claim 21, wherein the at least one compound comprises a thermoelectric figure of merit greater than 1 at temperatures between about 550 K and about 700 K.

26. A method of using a thermoelectric material comprising:
providing a thermoelectric material comprising at least one compound having a general composition of A_{w-t}Te₁Dₜ, wherein w>t, 0<t≦0.05, wherein A is selected from the group consisting of lead and tin, Te is tellurium, and D consists of indium; and
exposing at least one portion of the at least one compound to a temperature greater than about 550 K during use of the thermoelectric material.

27. The method of claim 26, wherein 0.01≦t≦0.03.

28. The method of claim 26, wherein the at least one compound further comprises selenium.

29. The method of claim 28, wherein a concentration of the selenium is between about 0.5 and about 5 atomic percent of the at least one compound.

30. The method of claim 26, wherein A consists essentially of tin.
